(19) United States
(12) Patent Application Publication
(10) Pub. No.: US 2026/0179367 A1
(43) Pub. Date: Jun. 25, 2026

(54) MACHINE LEARNING SYSTEMS AND METHODS FOR ONLINE DETECTION OF OBJECTS IN IMAGES

(71) Applicant: Schneider Electric USA, Inc., Boston, MA (US)

(72) Inventor: Pranshu Tiwari, Grafton, MA (US)

(73) Assignee: Schneider Electric USA, Inc., Boston, MA (US)

(21) Appl. No.: 18/988,813

(22) Filed: Dec. 19, 2024

(51) Int. Cl. G06V 10/776; G06T 7/12; G06T 7/194; G06V 10/44

(52) U.S. Cl. CPC G06V 10/776; G06T 7/12; G06T 7/194; G06V 10/44; G06T 2207/20081; G06T 2207/20084; G06V 2201/07

(57) ABSTRACT

Techniques for online detection of objects in images using a set of trained machine learning (ML) models. The techniques include: (a) responsive to receiving images of objects of a first type, processing the received images, using a selected trained ML model from among the set of trained ML models, to segment objects of the first type in the images to obtain respective segmentation masks; (b) during performance of (a) evaluating performance of multiple ML models using measure(s) of performance; identifying, based on the evaluating, a particular trained ML model; when the selected trained model is identified as the particular trained ML model, continuing (a) using the selected trained ML model, otherwise continuing performance of (a) using the particular trained ML model instead of the selected trained ML model.

### FIELD

Aspects of the present disclosure relate to machine learning (ML) techniques for segmenting objects in images from their backgrounds. The techniques include a novel multi-encoder ML segmentation model and methods of using same. The techniques also include a novel online process for object detection in images using multiple trained ML models, which may include the multi-encoder ML segmentation model.

### BACKGROUND

Image segmentation refers to the process of dividing images into groups of pixels, sometimes referred to as portions or segments. Often, image segmentation is performed such that the identified image segments or portions can be further processed as part of tasks such as object detection (e.g., identifying humans or cars in an image) and classification (e.g., identifying types of objects in an image). There are a variety of image segmentation techniques that rely on machine learning methods including deep learning methods.

Some image segmentation methods aim to separate one or more objects from their respective backgrounds. For example, an image segmentation method may be applied to an image of one or multiple objects (e.g., cars) to separate “object” pixels in the image (e.g., the pixels showing the car(s)) from “background” pixels in the image (e.g., the pixels showing anything other than the car(s)). In this example, an image segmentation method may only differentiate between object(s) and their background, but not among the objects themselves (e.g., pixels are labeled as “car” pixels or “background” pixels only). Such an image segmentation method may be termed a “semantic segmentation” method. On the other hand, some image segmentation methods may not only differential between objects and their background, but also among the objects themselves (e.g., “car” pixels are labeled differently depending on which car they show) such that the resulting labeling of pixels allows for distinguishing among different object instances (e.g., different cars) shown in the image. Such an image segmentation method may be termed an “instance segmentation” method.

### SUMMARY

Some embodiments provide for a method for detecting objects in images using machine learning (ML). The method comprises using at least one computer hardware processor to perform: obtaining an image of an object; and segmenting the object in the image from background of the object in the image to obtain a segmentation mask for the image. The segmenting comprises: processing the image with a first trained ML model to obtain first image features; transforming the first image features to second image features for processing by a second trained ML model; and processing the second image features using the second trained ML model to obtain the segmentation mask for the image, wherein the segmentation mask identifies pixels associated with the object in the image and pixels associated with background of the object in the image.

Some embodiments provide for a system, comprising: at least one computer hardware processor; and at least one non-transitory computer-readable storage medium storing processor-executable instructions that, when executed by the at least one computer hardware processor, cause the at least one computer hardware processor to perform a method for detecting objects in images using machine learning (ML), the method comprising: obtaining an image of an object; and segmenting the object in the image from background of the object in the image to obtain a segmentation mask for the image, the segmenting comprising: processing the image with a first trained ML model to obtain first image features; transforming the first image features to second image features for processing by a second trained ML model; and processing the second image features using the second trained ML model to obtain the segmentation mask for the image, wherein the segmentation mask identifies pixels associated with the object in the image and pixels associated with background of the object in the image.

Some embodiments provide at least one non-transitory computer-readable storage medium storing processor-executable instructions that, when executed by at least one computer hardware processor, cause the at least one computer hardware processor to perform a method for detecting objects in images using machine learning (ML), the method comprising: obtaining an image of an object; and segmenting the object in the image from background of the object in the image to obtain a segmentation mask for the image, the segmenting comprising: processing the image with a first trained ML model to obtain first image features; transforming the first image features to second image features for processing by a second trained ML model; and processing the second image features using the second trained ML model to obtain the segmentation mask for the image, wherein the segmentation mask identifies pixels associated with the object in the image and pixels associated with background of the object in the image.

Some embodiments provide for a method for detecting objects in images using machine learning (ML). The method comprises: using at least one computer hardware processor to perform: obtaining an image of an object; and segmenting the object in the image from background of the object in the image to obtain a segmentation mask for the image by using multiple trained encoders including: a first encoder whose weights are obtained by transfer learning; and a second encoder whose weights are trained using images of objects of a same type as the object, wherein the segmentation mask identifies pixels associated with the object in the image and pixels associated with background of the object in the image.

Some embodiments provide for a system, comprising: at least one computer hardware processor; and at least one non-transitory computer-readable storage medium storing processor-executable instructions that, when executed by the at least one computer hardware processor, cause the at least one computer hardware processor to perform a method for detecting objects in images using machine learning (ML), the method comprising: obtaining an image of an object; and segmenting the object in the image from background of the object in the image to obtain a segmentation mask for the image by using multiple trained encoders including: a first encoder whose weights are obtained by transfer learning; and a second encoder whose weights are trained using images of objects of a same type as the object, wherein the segmentation mask identifies pixels associated with the object in the image and pixels associated with background of the object in the image.

Some embodiments provide for at least one non-transitory computer-readable storage medium storing processor-executable instructions that, when executed by at least one computer hardware processor, cause the at least one computer hardware processor to perform a method for detecting objects in images using machine learning (ML), the method comprising: obtaining an image of an object; and segmenting the object in the image from background of the object in the image to obtain a segmentation mask for the image by using multiple trained encoders including: a first encoder whose weights are obtained by transfer learning; and a second encoder whose weights are trained using images of objects of a same type as the object, wherein the segmentation mask identifies pixels associated with the object in the image and pixels associated with background of the object in the image.

Some embodiments provide for a method for online detection of objects in images using a set of trained machine learning (ML) models. The method comprises using at least one computer hardware processor to perform: (a) responsive to receiving images of objects of a first type, processing the received images, using a selected trained ML model from among the set of trained ML models, to segment objects of the first type in the images to obtain respective segmentation masks; (b) during performance of (a) and either in accordance with a prespecified schedule and/or responsive to one or more triggering events, evaluating performance of the selected trained ML model and one or more other trained ML models in the set of trained ML models using one or more measures of performance; identifying, from among the selected trained ML model and the one or more other trained ML models, a particular trained ML based on its performance on the one or more measures of performance and in accordance with one or more ML model selection rules; when the selected trained model is identified as the particular trained ML model, continuing performance of (a) using the selected trained ML model; and when the selected trained ML model is not identified as the particular trained ML model, continuing performance of (a) using the particular trained ML model instead of the selected trained ML model and treating the particular trained ML model as the selected trained ML model next time (b) is performed.

Some embodiments provide for a system, comprising: at least one computer hardware processor; and at least one non-transitory computer-readable storage medium storing processor executable instructions that, when executed by the at least one computer hardware processor, cause the at least one computer hardware processor to perform a method for online detection of objects in images using a set of trained machine learning (ML) models, the method comprising: (a) responsive to receiving images of objects of a first type, processing the received images, using a selected trained ML model from among the set of trained ML models, to segment objects of the first type in the images to obtain respective segmentation masks; (b) during performance of (a) and either in accordance with a prespecified schedule and/or responsive to one or more triggering events, evaluating performance of the selected trained ML model and one or more other trained ML models in the set of trained ML models using one or more measures of performance; identifying, from among the selected trained ML model and the one or more other trained ML models, a particular trained ML based on its performance on the one or more measures of performance and in accordance with one or more ML model selection rules; when the selected trained model is identified as the particular trained ML model, continuing performance of (a) using the selected trained ML model; and when the selected trained ML model is not identified as the particular trained ML model, continuing performance of (a) using the particular trained ML model instead of the selected trained ML model and treating the particular trained ML model as the selected trained ML model next time (b) is performed.

Some embodiments provide for at least one non-transitory computer-readable storage medium storing processor-executable instructions that, when executed by at least one computer hardware processor, cause the at least one computer hardware processor to perform a method for online detection of objects in images using a set of trained machine learning (ML) models, the method comprising: (a) responsive to receiving images of objects of a first type, processing the received images, using a selected trained ML model from among the set of trained ML models, to segment objects of the first type in the images to obtain respective segmentation masks; (b) during performance of (a) and either in accordance with a prespecified schedule and/or responsive to one or more triggering events, evaluating performance of the selected trained ML model and one or more other trained ML models in the set of trained ML models using one or more measures of performance; identifying, from among the selected trained ML model and the one or more other trained ML models, a particular trained ML based on its performance on the one or more measures of performance and in accordance with one or more ML model selection rules; when the selected trained model is identified as the particular trained ML model, continuing performance of (a) using the selected trained ML model; and when the selected trained ML model is not identified as the particular trained ML model, continuing performance of (a) using the particular trained ML model instead of the selected trained ML model and treating the particular trained ML model as the selected trained ML model next time (b) is performed.

The foregoing summary is non-limiting.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A is a diagram illustrating application of a trained convolutional neural network with a U-Net architecture to an input image to produce a segmentation mask, in accordance with some embodiments of the technology described herein.

FIG. 1B is a diagram illustrating application of the trained convolutional neural network of FIG. 1A to an example input image of power electronics equipment to obtain a segmentation mask, in accordance with some embodiments of the technology described herein.

FIG. 2A is a diagram illustrating application of a multi-encoder ML segmentation model, including first and second trained ML models, to an image to obtain a segmentation mask separating one or more objects in the image from their background, in accordance with some embodiments of the technology described herein.

FIG. 2B is a diagram illustrating application of a multi-encoder neural network segmentation model, including a first encoder, a second encoder, and a trained convolutional neural network with a U-Net architecture, to an image to obtain a segmentation mask separating one or more objects in the image from their background, in accordance with some embodiments of the technology described herein.

FIG. 2C is a diagram illustrating application of a multi-encoder neural network segmentation model, including a transfer-learned encoder, an auto-encoder encoder, and a trained convolutional neural network with a U-Net architecture, to an image to obtain a segmentation mask separating one or more objects in the image from their background, in accordance with some embodiments of the technology described herein.

FIG. 3 is a block diagram of an illustrative image segmentation system, in accordance with some embodiments of the technology described herein.

FIG. 4A is a flowchart of an illustrative process 400 for detecting objects in images using machine learning, in accordance with some embodiments of the technology described herein.

FIG. 4B is a flowchart of another illustrative process 450 detecting objects in images using machine learning, in accordance with some embodiments of the technology described herein.

FIG. 5A illustrates performance of various ML-based segmentation techniques on an example task of segmenting a power equipment component from its background, in accordance with some embodiments of the technology described herein.

FIG. 5B illustrates aspects of the process of training an instance of a multi-encoder neural network segmentation model, in accordance with some embodiments of the technology described herein.

FIGS. 6A-6B illustrate aspects of computations that may be performed as part of using a multi-encoder neural network segmentation model, in accordance with some embodiments of the technology described herein.

FIG. 7 is a flowchart of an illustrative process for online detection of objects in images using a set of trained machine learning (ML) models, in accordance with some embodiments of the technology described herein.

FIGS. 8A and 8B illustrate aspects of determining an intersection over union (IOU) metric for segmentation performance, in accordance with some embodiments of the technology described herein.

FIG. 9 is a block diagram of an illustrative computing system that may be used in implementing some embodiments of the technology described herein.

### DETAILED DESCRIPTION

This disclosure describes new machine learning techniques for image segmentation, developed by the inventor. First, the disclosure describes a novel ML model that can be used for image segmentation, including semantic segmentation. The ML model has a new architecture with multiple encoders, which allows the ML model to take advantage of transfer learning to learn feature representations and results in overall improved performance over conventional ML image segmentation methods. As the ML model includes multiple encoders, it may be referred to herein as a “multi-encoder ML segmentation model”. Its architecture is different from that of conventional ML image segmentation models, as described herein.

Second, the disclosure describes a novel technique for online detection of objects in images using multiple trained ML models for image segmentation. The technique may involve online monitoring of the performance of multiple trained ML models by evaluating their performance using on one or more performance measures (e.g., segmentation performance, computational complexity, etc.) and using the results of the evaluation to adapt which of the multiple trained ML models is to be used going forward (e.g., until the next evaluation). The multiple ML models may include the multi-encoder ML segmentation model and/or any other suitable trained ML models for segmentation.

Each of these innovative aspects of the technology may be used for a variety of applications including for detecting objects of interest in images for various tasks including anomaly detection. And while the techniques described herein are not limited to being applied to anomaly detection, they can help to address various challenges that arise in that context.

Detecting anomalies in imaged objects (e.g., detecting anomalies in electronics equipment, such as power electronics equipment, from images of the electronics equipment) is a challenging task for a number of reasons. First, there is not always a clear partition between normal and abnormal conditions. Second, there may be significant background noise in the images (e.g., in aerial images of power electronics equipment, images obtained by video surveillance, etc.). Third, real-world anomalous behaviors and characteristics are diverse and there is often insufficient training data to faithfully represent all conceivable anomalous behaviors and characteristics that arise in different environments. As a result, some anomalies are likely represented more faithfully in available data than others, and some might not be represented well or at all, as the case may be with new or previously undetected types of anomalies. Such scarcity and sparsity of available training data makes it challenging if not impossible for conventional machine learning methods to reliably detect anomalies that are not well represented in the available data. The fact that anomalies arise in a variety of different contexts and may be of different types exacerbates the scarcity and sparsity problem.

By contrast, the techniques described herein can be used to address some of these issues arising in anomaly detection. In particular, the techniques described herein are better suited to identifying objects of interest in images, than conventional techniques, and do so more accurately. Increased accuracy in identifying objects of interest in images by separating such objects from their background (e.g., by identifying power electronics equipment in images by separating any such equipment from its background) in turn improves detection of any anomalies associated with such objects of interest (e.g., anomalies occurring on the power electronics equipment).

Indeed, when attempting to detect anomalies for a variety of different types of objects imaged against varying backgrounds, it is important to first isolate the objects of interest in these images by separating them from their backgrounds. For instance, in scenarios involving images captured by unmanned aerial vehicles (UAVs) such as drones, for example images of electrical towers and power electronics equipment thereon (e.g., circuit breakers, power insulators, transformers, etc.), identifying the power electronics equipment in such images would be a first step in the anomaly detection process. Such a process may, for example, include subsequent machine learning techniques to autonomously identify patterns and groupings within images of the objects of interest, which can greatly aid in the subsequent labeling process, and training ML models (e.g., classifiers) for identifying anomalies. As an illustrative example, the extracted images of objects may be processed using an unsupervised ML technique (e.g., clustering) to identify different types of anomalies (that can be seen in imagery), which can help manufacturers and/or operators determine their cause(s). To this end, the extracted images of objects may be clustered to identify “types” or “themes” of anomalies. In turn, various classification techniques may be trained, using supervised learning, to generate classifiers (e.g., the Faster R-CNN) to identify different classes of anomalies that may be present in images.

### Novel ML Model for Image Segmentation

As described above, among various innovations, this application describes a novel ML model for image segmentation, which may be termed a “multi-encoder ML segmentation model”.

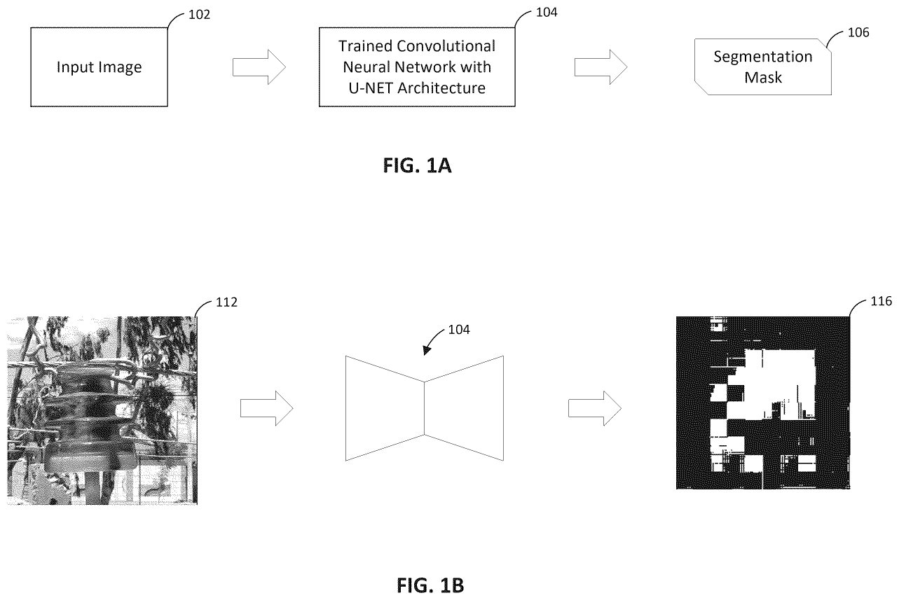

Machine learning has been previously used for image segmentation. For example, as shown in FIG. 1A, a trained convolutional neural network 104 having a U-Net architecture may be applied to an input image 102 to produce a segmentation mask 106. A convolutional neural network (CNN) having a U-Net architecture may be composed of a series of neural network layers (e.g., convolutional and pooling layers) forming a downsampling path followed by a series of neural network layers (e.g., convolutional and upsampling layers) forming an upsampling path. The downsampling and upsampling paths are usually symmetric, which provides the CNN with a “U”-like architecture. The U-Net architecture also includes skip connections between downsampling path layers and corresponding upsampling path layers, which allows layers along the upsampling path to have access to both coarse- and fine-level details. Aspects of convolutional neural networks having a U-Net architecture are further described in Ronneberger, O., Fischer, P., Brox, T. (2015). U-Net: Convolutional Networks for Biomedical Image Segmentation. In: Navab, N., Hornegger, J., Wells, W., Frangi, A. (eds.) Medical Image Computing and Computer-Assisted Intervention-MICCAI 2015. MICCAI 2015. Lecture Notes in Computer Science( ) vol 9351. Springer, Cham, which is incorporated by reference here in its entirety.

FIG. 1B further illustrates application of the trained convolutional neural network 104 (shown in FIG. 1A) to an example input image 112 of power electronics equipment to obtain an output segmentation mask 116, in accordance with some embodiments of the technology described herein.

One drawback of conventional deep learning approaches (e.g., using a trained CNN with a U-Net architecture) to image segmentation is that performance of such approaches is heavily reliant on the types of objects seen in the training data. Performance on segmenting objects in the training data from their backgrounds is better than on objects not well represented in the training data. As an illustrative example, a U-Net CNN may be trained on images of power electronics equipment of a certain type (e.g., pin insulators and suspension insulators) and may perform well in segmenting that type of power electronics equipment from background in images. However, the performance of that same U-Net CNN on segmenting (from their backgrounds in images) other types of power electronics equipment (e.g., post insulators and shackle insulators), which are not well represented in the training data, may be substantially worse. This may be, in part, because the other types of power electronics equipment have different visual characteristics (e.g., different types of geometry, shape, edge structure, size, etc.) than the power electronics equipment in the training data and/or in part because those types of power electronics equipment may appear in the context different types of backgrounds.

One possible solution to this problem is obtaining more images of different types of object of interest (e.g., getting more images of different types of power electronics equipment). However, as described above, getting more training data is not always possible. Gathering additional training data is time consuming and expensive. For example, using UAVs to image power electronics equipment is clearly an expensive task, made even more complex and expensive by the sheer number of different types of electronics equipment, the differing background conditions (e.g., urban, suburban, rural, forest, weather such as rain/snow/ice, etc.), and the broad area of deployment of such devices. In the context of anomaly detection, some anomalies may not have been seen or formed and so even if all such equipment could be imaged, those images might not faithfully capture all anomalies that could possibly occur. And, of course, new types of power electronics equipment could be introduced as new products and newer generations of older products are introduced.

To address the above-described drawbacks of conventional deep learning approaches to image segmentation, the inventor recognized that the lack of suitable training data may be addressed through the use of transfer learning. To this end, the inventor developed a new ML model for image segmentation whose architecture includes a transfer-learned portion, which has been previously trained on a large diverse dataset of images, and which allows the new ML model to extract image features that have been previously observed and/or learned from a much wider set of objects in such a dataset (e.g., people, cars, pets, environments, houses, man-made devices, computers, power lines, etc.) than just the objects of a particular type of interest for which training data may be limited (e.g., images only of power electronics equipment).

In some embodiments, the transfer-learned portion may be a portion of another previously-trained ML model (e.g., a neural network model having a ResNet architecture, a visual geometry group (VGG) architecture, an Inception architecture, etc.) and may be used to encode the image to produce a first set of image features. These features may be higher-dimensional than the image itself and may represent a variety of image features extracted from the image based on image features seen in the larger dataset on which the other previously-trained ML model was trained (a dataset that includes not only images of power electronics equipment, but images of many other types of items). In turn, these features may be subsequently processed by a second ML model, which may be conventional image segmentation model (e.g., a CNN having a U-Net architecture), to obtain a segmentation mask.

However, the inventor also recognized that the dimensionality of the first features obtained using the transfer learned portion (e.g., feature maps produced by a series of ResNet layers) may be different from the expected dimensionality of the input to the second ML model. To address this disparity, the new ML model architecture described herein includes a component for transforming the first set of image features (output by the transfer-learned portion) to a second set of image features (having suitable dimensionality for and) for subsequent processing by the second ML model. This component may be implemented as the encoder branch of an autoencoder whose transform space has the same dimensionality and/or shape as the input to the second ML model.

In this way, an input image of an object may be: (1) processed by a transfer-learned portion of another model such as ResNet, which portion may be considered a “first encoder”) to obtain first image features; (2) the first image features may be subsequently transformed (e.g., by an encoder portion of autoencoder, which may be considered a “second encoder”) to obtain second image features; and (3) the second image features may be processed by a second ML model, such as a CNN with U-Net architecture, to obtain a segmentation mask indicating pixels of the object and pixels of the background.

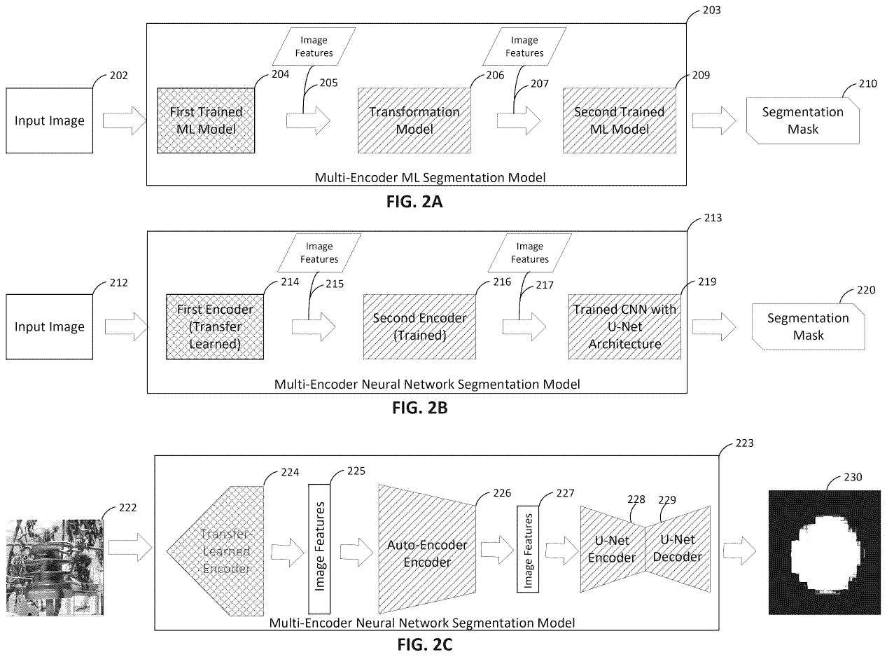

Since the first and second steps ((1) and (2)) each makes use of a respective encoder, the overall model capturing (1), (2), and (3), may be considered as a multi-encoder ML segmentation model, with step (1) using a first encoder (e.g., transfer-learned portion of another ML model, such as ResNet, VGG, Inception, etc.) and step (2) using a second encoder (e.g., the encoding branch of an autoencoder). It should be noted that the (neural network layers in the) downsampling path of a neural network having a U-Net architecture can be considered an “encoder” and the (neural network layers in the) upsampling path can be considered a “decoder”. This “encoder” may then be considered a third encoder in the overall architecture and it is distinct from the first and second encoders described herein as part of the multi-encoder ML segmentation models, as is described herein including with reference to FIGS. 2A, 2B, and 2C.

In some embodiments, the second encoder and second ML model used in step (2) and (3) of the above described process may be trained using task specific data (e.g., using labeled images of power electronics equipment), while the first encoder is transfer learned such that its parameter values have been previously determined by training on a dataset having images of a wide range of objects). In this way, the available training data may be leveraged for learning a portion of the multi-encoder ML segmentation model, but need not be used to learn how to extract image features from the image itself—that may be done using a transfer-learned encoder. As such, the resulting multi-encoder ML segmentation model includes a portion that is transfer learned and a portion that is learned from the training data that is available.

The resulting multi-encoder ML segmentation model therefore takes advantage of the transfer learned representations learned from a much wider range of data (including images of various types of objects) than is available for a particular type of object (e.g., power electronics equipment), which allows the resulting model to have improved segmentation performance especially in cases where segmentation is to be performed on images of objects or anomalies or backgrounds previously not seen or not sufficiently represented in the training data available for the particular type of object. As a result, the multi-encoder ML segmentation model results in improved performance relative to a conventional segmentation model (e.g., a CNN U-Net model) even with the same amount of training data available for the particular type of object.

Accordingly, some embodiments provide for a method for detecting objects in images using machine learning, the method including: (a) obtaining an image of an object; and (b) segmenting the object in the image from background of the object in the image to obtain a segmentation mask for the image, the segmenting comprising: (1) processing the image with a first trained ML model (e.g. first trained ML model 204, first encoder 214, or transfer learned encoder 224 shown in FIGS. 2A-2C, respectively) to obtain first image features (e.g., image features 205, 215, 225 shown in FIGS. 2A-2C respectively; (2) transforming the first image features (e.g., 205, 215, 225) to second image features (e.g., image features 207, 217, 227, shown in FIGS. 2A-2C respectively) for processing by a second trained ML model (e.g., 209, 219, 229, shown in FIGS. 2A-2C respectively); and (3) processing the second image features (e.g., 205, 215, 225) using the second trained ML model (e.g., 209, 219, 229) to obtain the segmentation mask (e.g., 210, 220, 230) for the image (e.g., 202, 212, 222), wherein the segmentation mask identifies pixels associated with the object in the image and pixels associated with background of the object in the image.

Any suitable images may be processed by the techniques described herein. For example, the images may be images of power electronics equipment (e.g., circuit breaker, power insulator, transformer, any power electronics equipment on a transmission tower, etc.), but the techniques described herein are not limited in their applicability to only power electronics equipment and may be used in any other suitable context. In addition, images to be processed by the techniques described herein may be obtained in any suitable way (e.g., by person capturing an image with a camera, by an unmanned aerial vehicle (e.g., a drone) or manned aerial vehicle (e.g., a plane, helicopter, etc.) having one or more cameras onboard, etc.), as aspects of the technology described herein are not limited in this respect.

In some embodiments, processing the image with the first trained ML model to obtain first image features comprises encoding the image using the first trained ML model to obtain the first image features. The first image features may comprise feature maps determined by processing the image using the portion of the first trained ML model. The first trained ML model may be a neural network model, for example, a neural network model having a series of convolutional layers. The first trained ML model may be a portion of a trained neural network having a ResNet architecture, a visual geometry group (VGG) architecture, or an Inception architecture. For example, the first trained ML model may consist of the first two, three, four, five, etc., layers of the ResNet model.

Accordingly, in some embodiments, at least some or all the values of the parameters of the first trained ML model may be obtained from a previously-trained neural network. Taking parameter values of one model from corresponding values in another model (having a compatible architecture) may be referred to as transfer learning because it involves transferring the information/knowledge captured by one model to another. Setting the values of at least some or all of parameters of the first trained ML model using parameter values of a previously-trained other ML model (e.g., having a ResNet architecture) may be considered as transfer learning in the context of the disclosure provided herein. As described herein, this is valuable where the previously-trained ML model was trained on image data including numerous types of objects (e.g., people, cars, pets, environments, houses, man-made devices, computers, power lines, etc.) of different type than the object (e.g., power insulator) in the image.

In some embodiments, the first ML model has at least 5K parameters, 10K parameters, at least 25K parameters, at least 50K parameters, at least 100K parameters, at least 250K parameters, at least 500K parameters, at least 1M parameters, at least 10M parameters, at least 50M parameters, between 5K and 50K parameters, between 10K and 100K parameters, between 25K and 250K parameters, between 50K and 50M parameters, or any other suitable range within these ranges.

In some embodiments, transforming the first image features to second image features for processing by the second trained ML model is performed by a using a trained ML transformation model. The ML transformation model may be an encoder of a trained autoencoder (AE) model or a trained variational autoencoder (VAE) model. The dimensionality and/or shape of the transform space of the trained AE or VAE model may match dimensionality and/or shape of input to second trained ML model such that the second image features may be provided as input to the second trained ML model and processed by the trained ML model.

In some embodiments, the ML transformation model has at least at least 5K parameters, 10K parameters, at least 25K parameters, at least 50K parameters, at least 100K parameters, at least 250K parameters, at least 500K parameters, at least 1M parameters, at least 10M parameters, at least 50M parameters, between 5K and 50K parameters, between 10K and 100K parameters, between 25K and 250K parameters, between 50K and 50M parameters, or any other suitable range within these ranges.

In some embodiments, the second trained ML model may be trained to segment, from background, objects of a same type as the type of the object. For example, the second trained ML model may be trained to segment, from background, power equipment objects. The second trained model may be a neural network model, for example, a neural network model comprising a series of convolutional layers. The neural network model may have a U-Net architecture. The neural network model may be a fully convolutional neural network model.

In some embodiments, the second ML model has at least at least 5K parameters, 10K parameters, at least 25K parameters, at least 50K parameters, at least 100K parameters, at least 250K parameters, at least 500K parameters, at least 1M parameters, at least 10M parameters, at least 50M parameters, between 5K and 50K parameters, between 10K and 100K parameters, between 25K and 250K parameters, between 50K and 50M parameters, or any other suitable range within these ranges.

In some embodiments, the first trained ML model may be trained on image data including images of numerous types of objects each of a different type than the object's type, and the second trained ML may be trained on image data including images of objects of a same type as the object's type. In this way, the multi-encoder ML segmentation model comprising the first trained ML model and the second trained ML model is trained using a combination of transfer learning (for obtaining parameters of the first ML model) and training on available dataset (for estimating parameters of the second ML model).

Aspects of the multi-encoder ML segmentation model are further described herein including with reference to FIGS. 2A-2C, 3, 4A-B, 5A-B, and 6A-B.

### Novel Technique for Online Detection of Objects in Imagery

In addition to developing a new multi-encoder ML segmentation model, as described herein, the inventor has developed a novel method for online detection of objects in imagery. In particular, the inventor has recognized that different ML segmentation algorithms may have different performance characteristics in different contexts and environments. For example, some ML segmentation algorithms may have better segmentation performance, but at the expense of increased computational complexity or vice versa. As another example, certain environments where such algorithms may be deployed could have limited computational power available for their execution (e.g., in a mobile platform). As yet another example, certain environments present challenging computer vision problems (e.g., complex and varied backgrounds sharing some visual characteristics with the objects of interest in the foregrounds), such that a more sophisticated segmentation algorithm is required to achieve target segmentation performance, notwithstanding the increased computational burden of executing a more complex algorithm.

Moreover, such conditions and requirements may change during the use/deployment of such models in various settings. With this in mind, the inventor has developed and this disclosure describes an online object detection technique whereby performance of ML segmentation algorithms being applied to received images may be evaluated, online, to determine whether the segmentation technique being presently used should be swapped out for another more suitable segmentation technique.

Accordingly, some embodiments provide for a method for online detection of objects in images using a set of trained machine learning (ML) models. The method comprises: (a) responsive to receiving images of objects of a first type, processing the received images, using a selected trained ML model from among the set of trained ML models, to segment objects of the first type in the images to obtain respective segmentation masks; (b) during performance of (a) and either in accordance with a prespecified schedule and/or responsive to one or more triggering events, (1) evaluating performance of the selected trained ML model and one or more other trained ML models in the set of trained ML models using one or more measures of performance; (2) identifying, from among the selected trained ML model and the one or more other trained ML models, a particular trained ML based on its performance on the one or more measures of performance and in accordance with one or more ML model selection rules; (3) when the selected trained model is identified as the particular trained ML model, continuing performance of (a) using the selected trained ML model; and (4) when the selected trained ML model is not identified as the particular trained ML model, continuing performance of (a) using the particular trained ML model instead of the selected trained ML model and treating the particular trained ML model as the selected trained ML model next time (b) is performed.

In some embodiments, the one or more measures of performance comprises a segmentation performance metric, which may be an intersection of over union (IOU) metric for measuring accuracy of segmenting objects of the first type in a set of one or more images. In some embodiments, the one or more measures of performance comprises a computational performance metric providing a measure of an amount of time used by an ML model to segment objects of the first type in a set of one or more images.

In some embodiments, the one or more ML model selection rules comprises a rule for selecting an ML model, from among a set of ML models, based on values of a computational performance metric and/or a segmentation performance metric for ML models in the set of ML models.

In some embodiments, the particular trained ML model is one of a U-Net neural network model, a multi-encoder ML segmentation model, and a K-means clustering algorithm. In some embodiments, the multi-encoder ML segmentation model comprises: a first encoder whose weights are obtained by transfer learning; a second encoder whose weights are trained using images of objects of a same type as the object; and a neural network model, wherein the first encoder is trained to process an image to obtain first image features, the second encoder is trained to transform first image features to second image features for subsequent processing by the neural network model, and the neural network model is trained to process the second image features to obtain a segmentation mask for the image, wherein the segmentation mask identifies pixels associated with the object in the image and pixels associated with background of the object in the image.

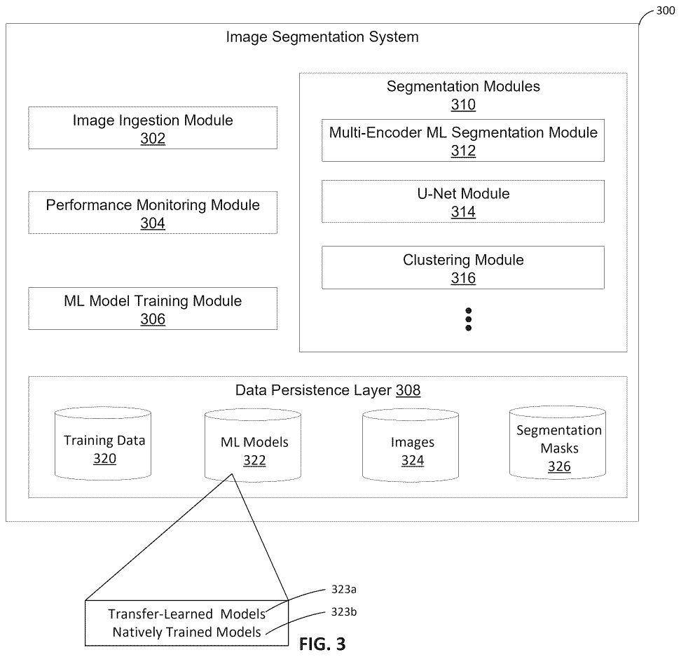

Aspects of the novel method for online detection of objects in imagery are further described herein including with reference to FIGS. 3, 7, and 8A-8B.

Following below are more detailed descriptions of various concepts related to, and embodiments of techniques for image segmentation using machine learning. Various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

FIGS. 1A and 1B describe a conventional approach to image segmentation using a convolutional neural network having a U-Net architecture. Drawbacks of such an approach are described above. FIGS. 2A-2C illustrate the improved approach to segmentation described herein based on a novel multi-encoder ML segmentation model.

In particular, FIG. 2A is a diagram illustrating application of a multi-encoder ML segmentation model, including first and second trained ML models, to an image to obtain a segmentation mask separating one or more objects in the image from their background, in accordance with some embodiments of the technology described herein.

As shown in FIG. 2A, a multi-encoder ML segmentation model 203 comprises three ML models operating in series including first trained ML model 204, transformation model 206 and second trained ML model 209. The second trained ML model 209 is trained to output a segmentation mask 210 by processing input features obtained from input image 202.

In the illustrated embodiment, an input image 202 may be processed using the first trained ML model 204 to obtain image features 205. Image features 205 may not have the shape and/or dimensionality of the input expected by the second trained ML model 209 and so have to be transformed to the appropriate shape and dimensionality using the transformation model 206. Thus, as shown in FIG. 2A, the image features 205 may be transformed by transformation model 206 to obtain image features 207, which in turn may be processed by the second trained ML model 209 to obtain the segmentation mask 210.

For example, the input image 202 may be a 224×224×3 image and may be processed by the first ML model to obtain feature maps having dimension 112×112×64 or 56×56×64 or 28×28×128 (e.g., when the first ML model contains the first one, first two, or first three convolutional layers of the ResNet34 neural network). On the other hand, the second trained ML model may be trained to segment images having dimension of 224×224×3. In this example, the transformation model would be used to transform the feature maps having dimension 112×112×64 (802,816 values) or 56×56×64 (200,704 values) or 28×28×128 (200,704 values) to the size and shape of 224×224×3 (150,528 values) that is expected by the second trained ML model.

It should be appreciated that the foregoing example is merely illustrative as any suitable number of layers from any other suitable neural network may be used as the first ML model (e.g., ResNet34, ResNet50, ResNet101, ResNet152, VGG16, VGG19, Inception v1, Inception v2, Inception v3, Inception v4, Inception-ResNet, AlexNet, DenseNet). Aspects of ResNet, including parameterizations of the 34, 50, 101, and 152 models) are described in He, K. et al. “Deep Residual Learning for Image Recognition.” CVPR (2016), which is incorporated by reference herein its entirety. Aspects of Inception-v4 and Inception-ResNet are described in Szegedy, Christian and Ioffe, Sergey and Vanhoucke, Vincent and Alemi, Alexander A., “Inception-v4, inception-ResNet and the impact of residual connections on learning”, 2017 Proceedings of the Thirty-First AAAI Conference on Artificial Intelligence, pp. 4278-428, which is incorporated by reference herein in its entirety. Aspects of VGG16 and VGG19 are described in Simonyan, Karen; Zisserman, Andrew, “Very Deep Convolutional Networks for Large-Scale Image Recognition,” published in the International Conference on Learning Representations (ICLR) 2015.

As described herein, the first trained ML model 204 may be considered as a first encoder of the image into first image features 205 and the transformation model 206 may be considered as a second encoder of the first image features into second image features 207 (hence giving rise to the terminology of a multi-encoder segmentation model). This is further illustrated in FIG. 2B. As shown in FIG. 2B, input image 212 is processed by multi-encoder neural network model segmentation 213 to obtain output segmentation mask 220. Processing by the multi-encoder neural network segmentation model 213 involves processing the input image 212 by the first encoder 214 to obtain first image features 215, transformation of the first image features 215 by the second encoder 216 into second image features 217, and processing of the second image features 217 by a trained CNN with a U-Net architecture 219 to obtain the segmentation mask 220.

In this example, the parameters of the first encoder may be transfer learned from another neural network previously trained on images of a variety of object types (e.g., not just images of power electronics equipment). For example, the first encoder may comprise one or multiple layers from a ResNet, VGG, or Inception type model, examples of which are described herein. By contrast, parameters of the second encoder 216 and the CNN model with U-Net architecture may be trained from available data (e.g., images of power electronics equipment). It should also be noted that although the second ML model is, in the example of FIG. 2B, shown to be a CNN with a U-Net architecture this is an example, and any other suitable ML segmentation model may be used in its place (e.g., a fully convolutional neural network). In the FIGS. 2A-2C components (204, 214, 224) that may be transfer learned are shaded with cross-hatching, while those components (206, 209, 216, 219, 226, 228, 229) in the architecture that may be trained from available data are shaded with hatching using diagonal lines parallel to one another).

FIG. 2C is another diagram illustrating application of a multi-encoder neural network segmentation model to an image to obtain a segmentation mask. In this example, the second encoder is instantiated as an encoder of an auto-encoder model with the transform space of the autoencoder having size and shape matching that of the input expected by the trained CNN model having a U-Net architecture.

As shown in FIG. 2C, input image 222 (image of a glass power insulator in this example) is processed by multi-encoder neural network segmentation model 223 to obtain output segmentation mask 230. Processing by the multi-encoder neural network segmentation model 223 involves processing the input image 222 by the first encoder 224 (whose parameters are transfer learned) to obtain first image features 225, transformation of the first image features 225 by the auto-encoder encoder 226 into second image features 227, and processing of the second image features 227 by a trained CNN with a U-Net architecture (comprising U-Net Encoder 228 and U-Net Decoder 229) to obtain the segmentation mask 220.

As shown in this example, the transfer learned encoder 224 may process the image (e.g., a 160×160×3 image) to obtain image features 225 (e.g., organized as a volume of 56×56×64 values) and the encoder 226 may transform the image features 225 into image features 227 (e.g., organized as a volume of a 160×160×3 image. In this way, the first encoder increases the dimensionality of the data by and generates higher-dimensional feature maps, which are then transformed, by the second encoder, into an appropriate shape and dimension to be subsequently processed by the U-Net model to obtain a segmentation mask.

FIG. 3 is a block diagram of an illustrative image segmentation system 300, in accordance with some embodiments of the technology described herein. The image segmentation system 300 includes multiple software modules including: image ingestion module 302, performance monitoring module 304, ML model training module 306, and segmentation modules 310. Each software module includes processor-executable instructions that, when executed by at least one computer hardware processor, causes the at least one computer hardware processor to perform the functionality of the software module. Also, as shown, the image segmentation system 300 includes a data persistence layer. Each of these components is described below.

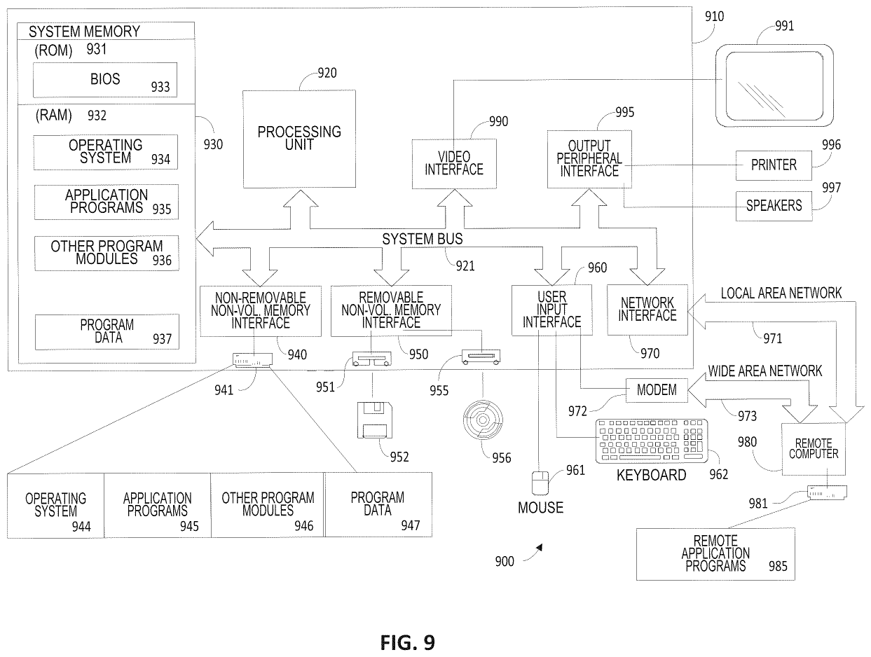

The image segmentation system 300 may be implemented using any suitable computing device(s). For example, the system may be implemented using one device (e.g., a desktop computer, a laptop computer, a server, any of the devices described with reference to FIG. 9) or multiple devices. When multiple devices are used, the devices may be physically distributed across multiple locations or located in a common physical location. In some embodiments, at least some (or all) of the functionality of the image segmentation system may be implemented using a cloud computing environment (which may be a public, a private or hybrid cloud computing environment).

In some embodiments, image ingestion module 302 may be configured to obtain an image to be segmented from one or more sources. The image ingestion module 302 may obtain an image from storage by accessing the image from the storage. The storage may include volatile memory (RAM) or non-volatile memory (e.g., disk). For example, image ingestion module 302 may obtain an image to be segmented from images data store 324 (an example of non-volatile memory), shown as part of data persistence layer 308. As another example, image ingestion module 302 may obtain an image by receiving it via a network connection. The image may be in any suitable image format and of any suitable size, as aspects of the technology described herein are not limited in this respect. The image may be a grayscale image (one channel), a color image (three channels), or have any other suitable number of channels depending on the type of sensor(s) used to capture the data used to form the image.

In some embodiments, the image ingestion module 302 may pre-process images before they are segmented. For example, image ingestion module 302 may pre-process an image before it is processed by a multi-encoder ML segmentation model (e.g., model 203, 213, or 223). To this end, an image may be zero-padded, denoised, filtered, and/or processed in any other suitable way, as aspects of the technology described herein are not limited in this respect.

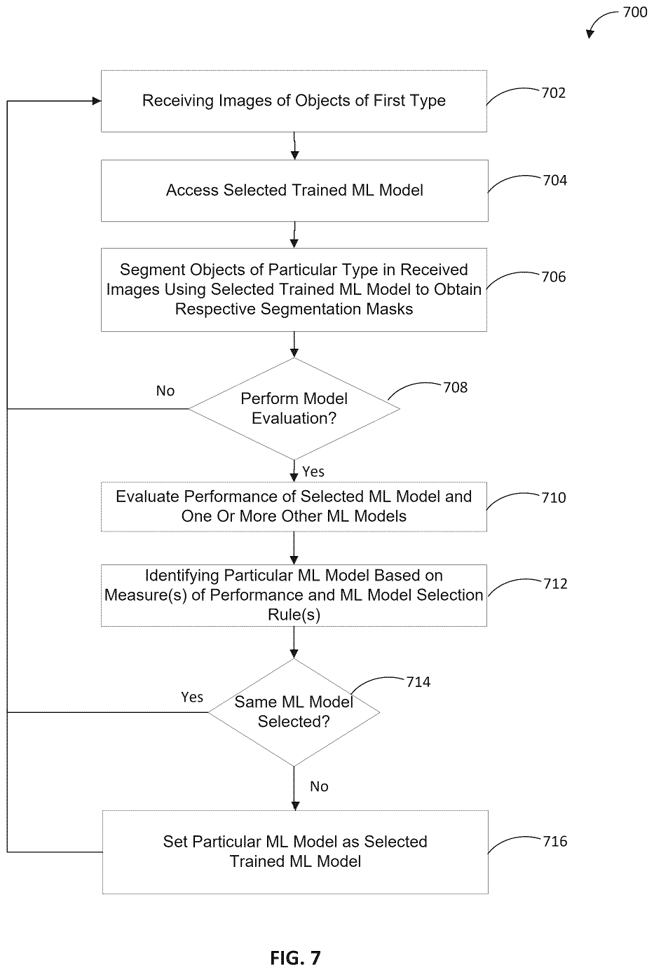

In some embodiments, the performance monitoring module 304 may be used to implement the techniques described herein for evaluating performance of one or more image segmentation techniques. In some embodiments, such evaluation may be done in an online setting as described herein with respect to the process 700 shown in FIG. 7. To this end, performance monitoring module 304 may include software for computing one or more measures of performance for each of one or more segmentation techniques, including any of the techniques implemented by segmentation modules 310. For example, performance monitoring module 304 may include software for evaluating segmentation performance metrics (e.g., an intersection over union IOU metric) and/or a computational performance metric (e.g., measuring an amount of time, processing power, memory and/or other computational resources used to segment one or more images).

In some embodiments, ML model training module 306 may include software for training one or more machine learning models. In some embodiments, this may involve transfer learning and may be performed by initializing a machine learning model (e.g., the first encoder described with respect to FIG. 2B) with parameter values from another previously-trained model (e.g., a ResNet model). The ML model so initialized may then be stored for subsequent use in ML models datastore 322 part of data persistence layer 308. Additionally or alternatively, the ML model so initialized may be further trained (e.g., fine-tuned) using training data available in training data store 320, part of data persistence layer 308.

In some embodiments, the ML model training module 306 may include software for train ML models from training. For example, module 306 may be programmed to train any suitable ML segmentation model from training data part of training data store 320. For example, module 306 may be programmed to train a convolutional neural network model (e.g., having a U-Net, a fully convolutional or other architecture) for a segmentation task (e.g., a semantic segmentation task). As another example, module 306 may be programmed to train an autoencoder or variational autoencoder model (e.g., to obtain second encoder 216 described with respect to FIG. 2B) to facilitate mapping of image features output by one ML model (e.g., first encoder 144) to inputs that will be processed by another ML model (e.g., trained CNN with U-Net architecture 219). To these ends, the ML model training module may have access to training data in training datastore and implement various training algorithms, including algorithms for training neural networks. For example, ML model training module may be include software configured to perform neural network training by gradient descent, stochastic gradient descent, and/or in any other suitable way. In some embodiments, the Adam optimizer may be used by the software. The Adam optimizer is described by Kingma, D. and Ba, J. ((2015) Adam: A Method for Stochastic Optimization. Proceedings of the 3rd International Conference on Learning Representations (ICLR 2015)), which is incorporated by reference herein in its entirety.

In some embodiments, the segmentation modules 310 may include software implementing one or more segmentation techniques, including any of the ML segmentation techniques described herein. For example, segmentation modules 310 may include multi-encoder ML segmentation module 312 that contains code for applying any of the multi-encoder ML segmentation models described herein (e.g., models 203, 213, and 223) to one or more images. The code may be configured to perform computations on an input image using parameter values of the various models part of the multi-encoder ML segmentation model to obtain a corresponding output segmentation mask. As another example, segmentation modules 310 may include U-Net module 314 that contains code for applying a CNN model having a U-Net architecture (e.g., models 209, 219, and 228 and 229) to one or more images. The code may be configured to perform computations on an input image using parameter values such a CNN model to obtain a corresponding output segmentation mask. As yet another example, segmentation modules 310 may include clustering module 316 that contains code for applying one or more clustering-based segmentation techniques (e.g., K-means based-clustering, mixture-of-Gaussian based clustering) to one or more images to obtain corresponding segmentation masks. It should be appreciated that segmentation modules 310 may include one or more other modules, in addition to or instead of the modules shown in FIG. 3, for implementing segmentation techniques.

As shown in FIG. 3, image segmentation system 300 includes data persistence layer 308 comprising multiple datastores including: training data datastore 320, ML models datastore 322, images datastore 324, and segmentation masks datastore 326.

Each data store may include one or multiple storage devices storing data in one or more formats of any suitable type. For example, the storage device(s) part of a data store may store data using one or more database tables, spreadsheet files, flat text files, and/or files in any other suitable format (e.g., a native format of a mainframe). The storage device(s) may be of any suitable type and may include one or more servers, one or more database systems, one or more portable storage devices, one or more nonvolatile storage devices, one or more volatile storage devices, and/or any other device(s) configured to store data electronically. In embodiments where a data store includes multiple storage devices, the storage devices may be co-located in one physical location (e.g., in one building) or distributed across multiple physical locations (e.g., in multiple buildings, in different cities, states, or countries). The storage devices may be configured to communicate with one another using one or more networks of any suitable type, as aspects of the technology described herein are not limited in this respect.

Also, although data persistence layer 308 is shown as being a part of system 300 in FIG. 3, in other embodiments one or more (or all) data stores part of layer 308 may be external to the image segmentation system 300, as aspects of the technology described herein are not limited in this respect.

In some embodiments, training data datastore 320 may store training data that may be used to train one or more ML models described herein. The training data may include images of objects of interest along with respective segmentations that may serve as “ground truth” during training. The “ground truth” segmentations may be obtained in any suitable way including by using manual or automated labeling.

In some embodiments, ML models datastore 322 may store parameters of trained ML models including any of the model described herein. For example, ML models datastore 322 may store parameters 323a of one or more transfer models (e.g., first encoder 214) and parameters 323b of one or more trained models (e.g., second encoder 216, trained CNN 219).

In some embodiments, images datastore 324 may store one or more images to be processed by the image segmentation system 300 and/or one or more images already processed by the image segmentation system 300. The images to be processed may be obtained by one or more cameras and/or other types of sensors and may be provided for processing to system 300, which may store the images in datastore 324 prior to and/or after processing.

In some embodiments, datastore 326 may store one or more results of the segmentations, including any segmentation masks obtained by applying one or more segmentation algorithms to one or more images. In addition, data store 326 may store one or more performance metrics computed based on one or more images processed by the image segmentation system 300.

It should be appreciated that although data persistence layer 308 contains four data stores in the example of FIG. 3, this is not a limitation, as in other embodiments there may be fewer (e.g., 1, 2, or 3) or more data stores. For example, one data store may be used to store all of the data used or generated by the image segmentation system (e.g., ML models, training data for same, images, and segmentation results).

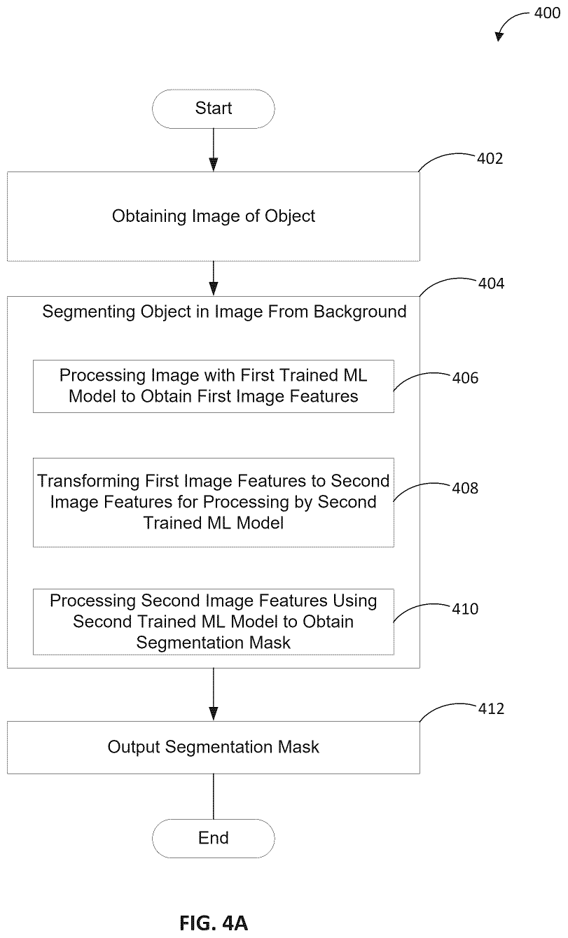

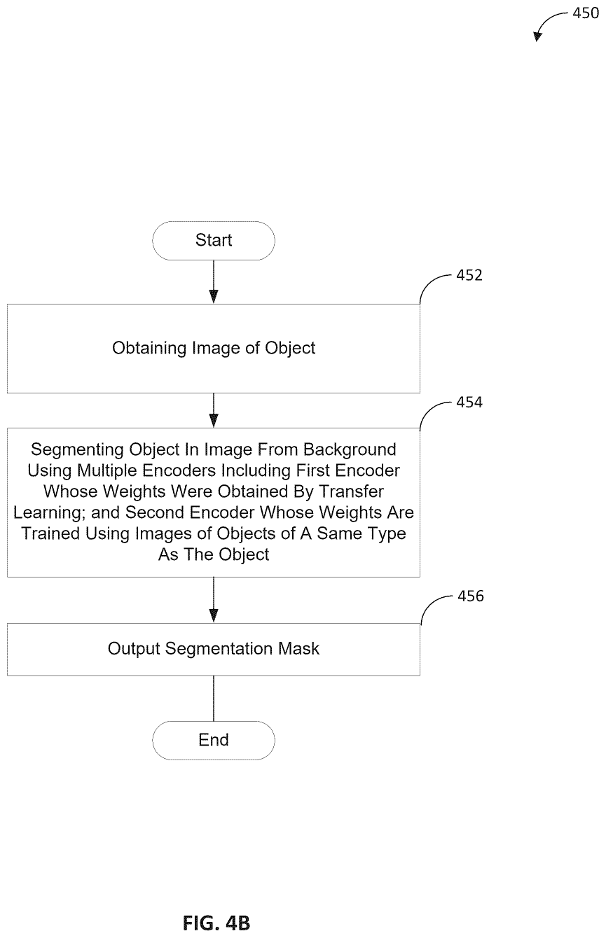

FIG. 4A is a flowchart of an illustrative process 400 for detecting objects in images using machine learning, in accordance with some embodiments of the technology described herein. Process 400 may be executed by any suitable computing device(s) and/or system. For example, process 400 may be executed by image segmentation system 300 described herein with reference to FIG. 3.

Process 402 begins at act 402, where an image of an object is obtained. The image may be of any suitable type of object and there may be multiple objects of that type in the image. For example, the image may be of power electronics equipment and there may be multiple instances of the power electronics equipment in the image. The image may be in any suitable image format and may be of any suitable size and/or resolution. In some embodiments, the image may have at least 10K, at least 50K, at least 100K, at least 500K, at least 1M pixel values. The image may be a single-channel image (e.g., a grayscale image) or a multi-channel image (e.g., a color image).

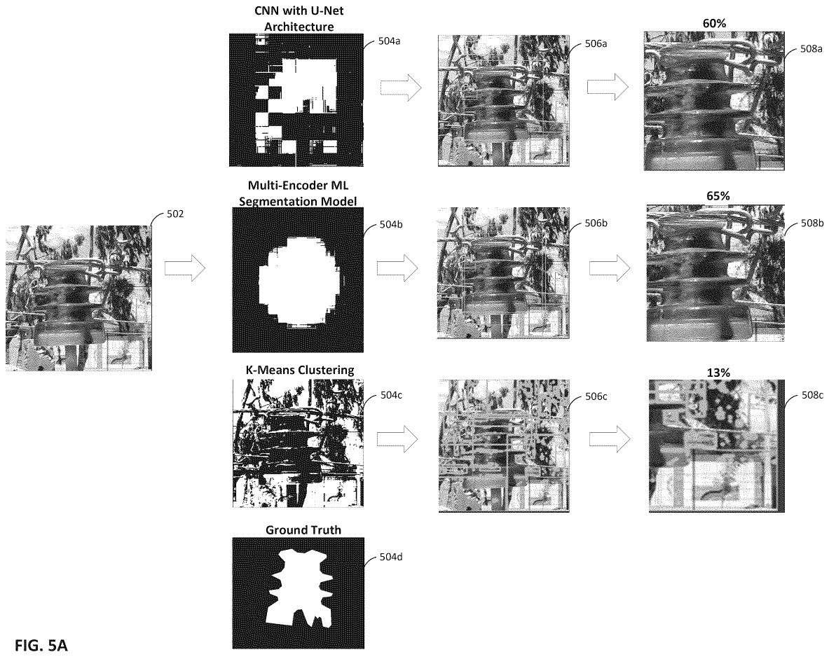

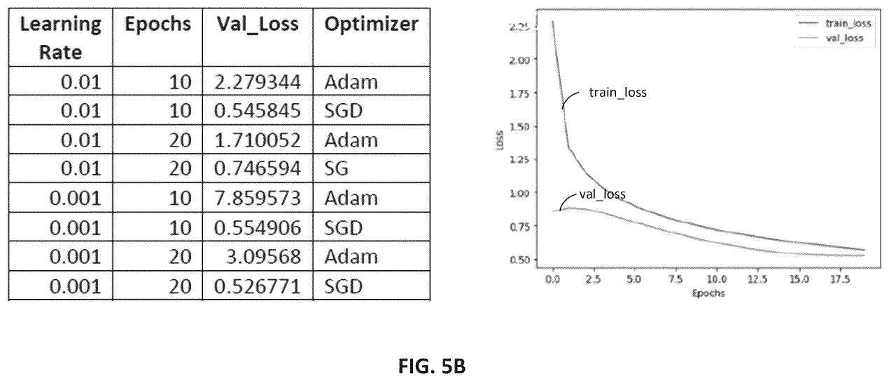

Next, process 400 proceeds to act 404, where the object(s) in the image are segmented from their background in the image to obtain a segmentation mask. The segmentation mask may identify pixels associated with the object(s) in the image and pixels associated with the background of the object(s) in the image. Examples of images and corresponding segmentation masks are shown in FIGS. 2C and 5A.

In some embodiments, a multi-encoder ML segmentation model may be used to perform the segmentation at act 404. That model may be any of the multi-encoder ML segmentation models described herein including, for example, models 203, 213, and 223. In some such embodiments, act 404 may comprise: processing, at act 406, the image obtained at act 402 using a first trained ML model to obtain first image features; transforming, at act 408, the first image features to second image features for processing by a second trained ML model; and processing, at act 410, the second image features using the second trained LM model to obtain the segmentation mask for the image.

In some embodiments, the first trained ML model (e.g., model 204, 214, 224) used at act 406 may be a neural network model. At least some parameter values of the neural network model may be transfer-learned. The first trained model may be a portion of another previously-trained neural network. The previously-trained neural network may have a ResNet, VGG, or Inception architecture. For example, first trained model may contain the first one, two, three, four five of the ResNet34, ResNet50, ResNet101, and ResNet152 models. Other examples of possible architectures are provided herein. In some embodiments, the first ML model has at least 5K parameters, 10K parameters, at least 25K parameters, at least 50K parameters, at least 100K parameters, at least 250K parameters, at least 500K parameters, at least 1M parameters, at least 10M parameters, at least 50M parameters, between 5K and 50K parameters, between 10K and 100K parameters, between 25K and 250K parameters, between 50K and 50M parameters, or any other suitable range within these ranges.

In some embodiments, the first image features may be feature maps having a higher dimension that the input image. For example, the input image 202 may be a 160×160×3 image and may be processed (e.g., after zero padding) by the first ML model to obtain feature maps having dimension 112×112×64 or 56×56×64 or 28×28×128 (e.g., when the first ML model contains the first one, first two, or first three convolutional layers of the ResNet34 neural network).

In some embodiments, the transformation performed at act 408 may be performed using an ML transformation model (e.g., model 206, 216, 226). The ML transformation model may be used to map the first image features to the second image features such that the shape and dimensionality of the second image features is suitable for processing by the second ML model.

In some embodiments, the ML transformation model may include an encoder portion of an autoencoder (AE) or variational autoencoder (VAE). The AE or VAE may have the shape and dimensionality of its transform space match that of the input to the second ML model. For example, if the first image features have dimension 56×56×64 and the input to the ML model has dimension 160×160×3, then to create the transformation model, an AE may be setup with the input and output dimensionality being 56×56×64, but the transform space (e.g., the bottleneck point) being of dimension 160×160×3. Thus, in this example, the encoder of the AE will map input from 56×56×64 to 160×160×3 and the decoder of the AE will map from 160×160×3 back to 56×56×64. Continuing this example, the ML transformation model used at act 208 would be the encoder of the AE mapping the input from 56×56×64 to 160×160×3. Of course, these numbers and examples are merely illustrative and non-limiting.

In some embodiments, the ML transformation model has at least at least 5K parameters, 10K parameters, at least 25K parameters, at least 50K parameters, at least 100K parameters, at least 250K parameters, at least 500K parameters, at least 1M parameters, at least 10M parameters, at least 50M parameters, between 5K and 50K parameters, between 10K and 100K parameters, between 25K and 250K parameters, between 50K and 50M parameters, or any other suitable range within these ranges.

In some embodiments, the second trained ML model may be trained to segment, from background, objects of a same type as the type of the object. For example, the second trained ML model may be trained to segment, from background, power equipment objects. The second trained model may be a neural network model, for example, a neural network model comprising a series of convolutional layers. The neural network model may have a U-Net architecture. The neural network model may be a fully convolutional neural network model.

In some embodiments, the second ML model has at least at least 5K parameters, 10K parameters, at least 25K parameters, at least 50K parameters, at least 100K parameters, at least 250K parameters, at least 500K parameters, at least 1M parameters, at least 10M parameters, at least 50M parameters, between 5K and 50K parameters, between 10K and 100K parameters, between 25K and 250K parameters, between 50K and 50M parameters, or any other suitable range within these ranges.

After segmentation is performed at act 404, the segmentation mask may be output at act 412. The segmentation mask may be stored (e.g., in data persistence layer 308, for example, in data store 326) and/or provided to one or more other software programs. The segmentation mask may have any suitable format and, for example, may be represented by a single-channel binary image, with one value indicating pixels of object(s) and the other value indicating background pixels.

FIG. 4B is a flowchart of another illustrative process 450 detecting objects in images using machine learning, in accordance with some embodiments of the technology described herein. Process 450 may be executed by any suitable computing device(s) and/or system. For example, process 400 may be executed by image segmentation system 300 described herein with reference to FIG. 3.

Process 450 begins at act 452, where an image of an object is obtained. This may be done in any suitable way including any of the ways described with reference to act 402 of process 400.

Next, process 450 proceeds to act 454, where the object in the image are segmented from their background in the image to obtain a segmentation mask. The segmentation mask may identify pixels associated with the object(s) in the image and pixels associated with the background of the object(s) in the image. Examples of images and corresponding segmentation masks are shown in FIGS. 2C and 5A.

At act 454, the object may be segmented from its background using multiple encoders including a first encoder whose parameter values (e.g., weights in the context of neural networks) were obtained by transfer learning and a second encoder whose parameter values were obtained by training using images of objects of a same type as the object in the image.

In some embodiments, the first encoder (e.g., first encoder 214, 224) may have an architecture mirroring that of a portion of another trained neural network model (e.g., ResNet, VGG, Inception, etc.) and its parameter values may be transfer learned from the portion of the other trained NN model. The transfer-learned parameter values, when they were previously estimated during training of the other NN model, may have been trained using image data including multiple types of objects of a different type (e.g., not just power electronics equipment) than the object's type (power electronics equipment).

In some embodiments, the second encoder (e.g., second encoder 216, 226) may be an encoder of an autoencoder setup to facilitate processing, by a second trained ML model, of image features output by the first encoder. To this end, the second encoder may map the image features output by the first encoder to second image features having the shape and dimension suitable for subsequent processing by the second ML model. Examples of this are provided herein.

In some embodiments, the second ML model may be any suitable trained ML segmentation model, for example, a trained CNN with a U-Net architecture (e.g., model 219) or a fully-convolutional architecture.

After segmentation is performed at act 454, the segmentation mask may be output at act 456. The segmentation mask may be stored (e.g., in data persistence layer 308, for example, in data store 326) and/or provided to one or more other software programs. The segmentation mask may have any suitable format and, for example, may be represented by a single-channel binary image, with one value indicating pixels of object(s) and the other value indicating background pixels.

### Example Application to Segmentation of Power Electronics Equipment

An illustrative application of a multi-encoder ML segmentation model is described next. In this example, a multi-encoder ML segmentation model was trained to process 160×160×3 images of power electronics equipment, including images of power insulators-glass insulators with rings.

In this example, the multi-encoder ML segmentation model includes a first encoder, a second encoder, and a CNN having a U-Net architecture. The first encoder has an architecture corresponding to multiple ResNet layers and was configured to process input images with dimensions of 224×224×3 (224×224 pixels in three channels), which input images were obtained by resizing (e.g., via zero padding) the 160×160×3 images. The parameters of the first encoder were transfer-learned from the ResNet (ResNet50 architecture in this example, though any ResNet architecture could be used). The first encoder was configured to process the input images to output feature maps dimensioned 7×7×2048. These output feature maps may be considered as a Bag of Images, which show the values encoded per pixel. Hence each pixel has 2048 features showing it has enough information learnt from the ResNet model. The second encoder was trained to map first image features (dimensioned 7×7×2048) generated by application of the ResNet layers to input images to second image features dimensioned (232,232,3) for subsequent processing by the U-Net. The second encoder was trained as part of an autoencoder, with downsampling performed using 3×3 filters and upsampling performed using transposed convolutions. Here the 3 channels do not represent the traditional R, G, B channels, but rather an encoded version of 2048 features which are the best representation when projected to 3 channels.

A dataset of 100 images was labeled utilizing polygon-based labeling. The polygon-based labeling was performed in Python, though other tools could have been used. Thus, a “ground truth” segmentation mask was generated for each of the 100 images in the dataset. The 100 images (and their masks) were divided into training data sets, validation data sets (for model selection and hyperparameter tuning), and test sets. The training set consisted of 67 images, including original and masked images created using polygon-based labeling. The target variable is a masked image, with pixel values ranging from 0 to 1. Values less than 0.5 were clipped to 0, and values greater than 0.5 were clipped to 1.

The second encoder was trained using the training set of images using reconstruction loss. The U-Net was trained using the training images using sparse cross entropy loss, meaning that weights of the U-Net were tuned to minimize sparse cross entropy loss. As shown in the left panel of FIG. 5B, the sparse cross entropy loss was calculated, for different combinations of learning rates (e.g., 0.01 and 0.001), number of epochs (e.g., 10 and 20), and optimization algorithms (e.g., stochastic gradient descent (SGD) and Adam Optimizer). The model having parameter values associated with lowest validation loss was selected as best model and applied to the test set. The right panel of FIG. 5B shows training and validation losses over multiple epochs computing using sparse cross entropy loss (which was used as each pixel was predicted as being either a foreground pixel (e.g., 1 representing object) or a background pixel (e.g., 0 representing background). The Adam Optimizer was used to produce the loss values shown in FIG. 5B.

FIG. 5A illustrates the performance of the resulting multi-encoder ML segmentation model and compares it to performance of a CNN having a U-Net architecture and a K-means clustering approach. As shown in FIG. 5A, image 502 was segmented: (1) using a CNN with a U-Net architecture to obtain segmentation mask 504a (the resulting bounding box and excised image are shown in 506a and 508a, respectively); (2) using the multi-encoder ML segmentation model to obtain segmentation mask 504b (the resulting bounding box and excised image are shown in 506b and 508b, respectively); and (3) using K-means clustering to obtain segmentation mask 504c (the resulting bounding box and excised image are shown in 506c and 508c, respectively). For comparison, the ground truth mask is shown in 504d.

The overall performance of these three algorithms was evaluated on the test dataset using the intersection-over-union (IoU) metric. As shown in the table below, the multi-encoder ML segmentation model outperforms the U-Net CNN and the K-clustering approaches (these numbers are also shown in FIG. 5A above 508a, 508b, and 508c.

TABLE 1
Performance of various segmentation techniques as measured
by IoU metric and showing that the multi-encoder ML segmentation
model outperforms the competing approaches.

| Segmentation Technique Algorithm | Performance via IoU Metric |
|---|---|
| Multi-Encoder ML Segmentation Model | 65% |
| CNN with U-Net Architecture | 60% |
| K-Means Clustering | 13% |

### Additional Aspects of Multi-Encoder ML Segmentation Model

Further aspects of the multi-encoder ML segmentation models are described below.

Let X be a unique set of images X={X₁, X₂, . . . . X_{N1}} where Xᵢ∈R^{M*N} and let Y be a unique set of images representing binary images Y={Y₁, Y₂, . . . . Y_{N2}}, where Yᵢ∈R^{M*N}. The binary images represent segmentation masks.

As described herein, in some embodiments, the multi-encoder ML segmentation model includes three portions: (1) a transfer learned portion (e.g., a portion of another neural network model such as ResNet); (2) a transformation portion (e.g., an encoder portion of an autoencoder); and (3) a segmentation model (e.g., a CNN U-Net).

Transfer Learning from ResNet Features

In some embodiments, a pre-trained deep learning model that has been trained on a large dataset, such as ResNet, VGG, or Inception may be used to extract features from images (captured e.g., by an aerial device) to obtain high level patterns and shapes. To this end, the vector images in X denoted by X_{I}∈R^{M*N} may be processed by a portion of the pre-trained deep learning model (e.g., ResNet, VGG, or Inception) to obtain first features.

Such patterns and shapes, as captured by the first image features, may be defined by weights obtained by transfer learning according to:

$${Z}^{′ ( i , j )} = ( X * {W}_{\{ TL \}} ) ( i , j ) = {\sum }_{m} {\sum }_{n} X ( m , n ) W ( i - m , j - n ) \qquad ( Eq . 1 )$$

where W^{{TL}} represent the transfer learned weights (equivalent to kernel), Z′^{(i,j)} represent the first image features extracted from the image by using the transfer-learned weights, X represents the original image, and Z′∈R^{p*p*D} represents a feature based image, with features extracted at an appropriate layer of the pre-trained deep learning model.

Let m∈h, n∈w, then the above metrics can be re-examined in matrix form as l=h*w and flattening the matrix in form X in the form l*1. Hence, converting the W{TL} kernel into shape (l, k) with zero-padding of the convolution operation may be achieved as illustrated for a simple example below.

Let W_{{TL}} be the following matrix:

$${W}_{\{ TL \}} = [ \begin{matrix}{W}_{\{ 1 , 1 \}} & {W}_{\{ 1 , 2 \}} & {W}_{\{ 1 , 3 \}} \\ {W}_{\{ 2 , 1 \}} & {W}_{\{ 2 , 2 \}} & {W}_{\{ 2 , 3 \}} \\ {W}_{\{ 3 , 1 \}} & {W}_{\{ 3 , 2 \}} & {W}_{\{ 3 , 3 \}}\end{matrix} ]$$

which can be reshaped as a matrix W for layer k:

$${W}_{k} * I = D$$

where: Wₖ∈R^{{4*1}}, I∈R^{{L}}& D∈R^{l}

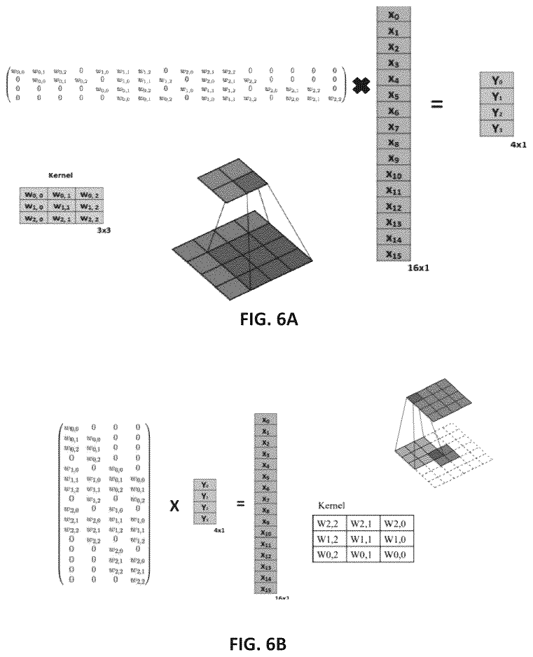

As shown in FIG. 6A, an example image X having a 4*4*1 shape, may be flattened to a 16×1 vector, and the 3×3 kernel of weights may be applied to it. To this end, the kernel has been padded to a 16×4 weight matrix as shown in FIG. 6A.

The first image features produced by ResNet (or any other suitable pre-trained deep learning model) may be the feature maps extracted at Layer [−i]. The feature maps may be denoted by Z′∈R^{p*p*D}, where p denotes the detailed feature map constructed, which can be thought of as bag of images or features of h′ and w.

As described herein, the image features produced by processing an input image with weights transfer learned from ResNet (or any other suitable deep learning model) may need to be further encoded to be transformed into a space suitable for subsequent processing by the CNN U-Net.

For example, let the weights be transfer learned from ResNet and be denoted by fᵣₑₛₙₑₜ. These weights may be used to process an input image X to obtain first image features Z′ as shown in the next equation:

$${Z}^{′} = {f}_{r e snet} ( X ) where {Z}^{′} {Z}^{′} ∈ {R}^{p * p * D} , X {R}^{m * n * 3} \qquad ( Eq . 2 )$$

The inventor recognized that before Z′ can be subsequently processed by the CNN U-Net, Z′ is to be converted back to a tensor shape which is the CNN U-Net expects (e.g., h*w*3), while capturing as much information and/or variation in Z′ as possible. One approach to this is to use an autoencoder framework.

In this framework, the autoencoder may be represented by Z′˜g(h(Z′)) where h(.) represents an encoder and g(.) the decoder. Then h(Z′) encodes the image features Z′ in a way that captures as much information (derived by using of the pre-trained deep learning model) as possible and decodes it back to Z″ to minimize reconstruction error or variance. These functions are further described below:

The encoder part of the autoencoder may be given by:

$$h : {Z}^{′} \to {N}^{′} , {N}^{′} ∈ {R}^{h * w * 3} , ( {W}_{\{ 1 \}} * {Z}^{′} + b ) σ ∼ {B}^{T} \cdot {Z}^{′} ; \qquad ( Eq . 3 )$$

$$W : weights of Neurons$$

and the decoder part may be given by:

$$g : {N}^{′} \to {Z}^{′′} , {Z}^{′′} ∈ {R}^{p * p * D} ; g : ( {W}_{2} * {N}^{′} + b ) {σ}^{′} \qquad ( Eq . 4 )$$

Hence, the reconstruction loss may be given by L, which may be computed across all images in the training set for estimating parameter values (Θ) of the encoder and decoder part of the autoencoder, with L defined by:

$${L ( Θ ) = ‖ {z}^{′} - {z}^{″} \vert}^{2} = {‖ {z}^{′} - ( {W}_{2} ( ( {W}_{1} \cdot {Z}^{′} + b ) * σ ) + {b}^{″} ) {σ}^{′} ‖}^{2} \qquad ( Eq . 5 )$$

Once the first image features Z′ are transformed to second image features having a tensor shape that is compatible with the CNN U-Net, the CNN U-Net may then be applied to generate a segmentation mask.

The CNN U-Net is based on a pixel-wise classification where each pixel has a probability value in pₖ(\vec{x}) where \vec{x}=[[x₁, x₂] represents the position of a pixel within the height and width of the image, while k represents the class of the pixel (e.g., a foreground pixel or a background pixel). Hence, when we create a model of N images and each image has a height h, width w and K classes, the CNN U-Net algorithm predicts y_{pred}∈R^{(h*w*K)} and the maximum probability among K classes is associated with a mask value m (varying from 0 or 1 in a binary image) for each image-pixel associated with height and weight.

A conventional CNN U-Net would process an image directly as its input. However, in the context of the multi-encoder ML segmentation approach described herein, the CNN U-Net processes a doubly-encoded image (the image is first encoded using transfer-learned weights to obtain image features Z′=fᵣₑₛₙₑₜ(Input Image), which are then encoded using the encoder of the autoencoder to obtain second image features h (Z′)). Thus, instead of the input image, the CNN U-Net receives h(fᵣₑₛₙₑₜ(Input Image)) as input.

The CNN U-Net may include down-sampling and up-sampling paths. Downsampling may be expressed according to:

$$D ( i , j ) = ( I * K ) ( i , j ) = {\sum }_{m} {\sum }_{n} {N}^{′ ( m , n )} K ( i - m , j - n ) \qquad ( Eq . 6 )$$

m∈h, n∈w, N′: Transformed Image from Auto Encoder. K—Weight Matrix The above calculations may be represented in matrix form as l=h*w, and by flattening the matrix X to a vector in the form l*1. Hence converting K metrics into shape 1 with zero padding of the convolution operation may be performed using weights according to:

$$K = [ \begin{matrix}{W}_{\{ 1 , 1 \}} & {W}_{\{ 1 , 2 \}} & {W}_{\{ 1 , 3 \}} \\ {W}_{\{ 2 , 1 \}} & {W}_{\{ 2 , 2 \}} & {W}_{\{ 2 , 3 \}} \\ {W}_{\{ 3 , 1 \}} & {W}_{\{ 3 , 2 \}} & {W}_{\{ 3 , 3 \}}\end{matrix} ]$$

obtained from weights to be reconstituted as matrix W*N=D, where, Wₖ∈R^{{K*l}}, N∈R^{{L}}& D∈R^{t} is flattened vector of shape m′ *n′ which are in lower dimension m′<m and n′<n, K: filter size, N is flattened vector of 1 elements, and 1=m*n.

Upsampling may be performed using transposed convolutions, for example according to:

$${W}^{T} * D = {X}_{PRED} ; \qquad ( Eq . 7 )$$

where W^{T}∈R^{{l*4}}, Dₖ∈R⁴; X_{PRED}∈R^{l} which is flattened version of h*w=1. This is further illustrated in FIG. 6B.

The above construct may be repeated in multiple layers of upsampling and downsampling according to:

$${X}_{p r e d} = {h}^{″} ( {h}^{′} ( {f}^{′} ( f ( {n}^{′} ) ) ) ) \qquad ( Eq . 8 )$$

where f, and f′ represent downsampling, h′ and h″ upsampling, and n′ represents image features in R^{m*n*3} obtained as h(fᵣₑₛₙₑₜ(Input Image)), where h( ) is the encoder of the autoencoder.

The cross-entropy calculated K classes across N image dataset post downsampling and upsampling may be calculated according to:

$$J ( \vec{w} ) = \frac{1}{h * w} ( ( 1 - {n}_{i} ) * log ( 1 - {x}_{i}^{′} ) + {\sum }_{1}^{K} {n}_{i} * log ( {x}^{′} ) ) \qquad ( Eq . 9 )$$

where w∈R^{M}, nᵢ is the image obtained from encoder and x′ is the predicted image.

### Additional Details on Other Types of Segmentation Techniques

The performance of the multi-encoder ML segmentation model may be compared against other types of segmentation techniques including the conventional CNN U-Net and K-means clustering, for example.

With respect to the U-Net, it may be applied directly to the input image rather than the doubly-encoded images as described above for in the case of the multi-encoder ML segmentation model. Analogous equations to the ones above apply. For example the downsampling path is given by:

$$D ( i , j ) = ( X * K ) ( i , j ) = {\sum }_{m} {\sum }_{n} X ( m , n ) K ( i - m , j - n ) \qquad ( Eq . 10 )$$

where N′ from Equation 6 is replaced by X, representing the original image to be segmented.

In matrix form, Equation 10 can be re-written as

$$W * X = D \qquad eq ( 11 )$$

where Wₖ∈R^{{K*1}}, X∈R^{l}, l is flattened vector obtained from m*n, &D∈R^{t} is flattened vector of shape m′*n′ which are in lower dimension m′<m and n′<n, K: filter size, X is flattened vector of l elements, and 1=h*w.

Upsampling is performed using transposed convolution according to:

$${W}^{T} * D = {X}_{PRED} ; \qquad ( Eq . 12 )$$

where W^{T}∈R^{{l*4}}, Dₖ∈R⁴; X_{pred}∈R^{l} which is flattened version of h*w. The loss function would be the same as provided in Eq. 9. The best X_{PRED} may selected as the best model among various filters used for the U-Net.
k-Clustering Based Models

In a K-means clustering based approach, each image may be flattened from X→X′ where X′ represents the flattened array with its value equal to l=h*w.X′∈R^{l*3}. We find clusters in these 3 dimensions among all pixels l in the image. Each pixel may be considered as a 3-dimensional vector and the objective of clustering would be to find the pixels in 3 dimensions which have similar intensity. This intensity mapping can be done on either image intensity or feature map of images obtained using following equation:

$$SSE = {\sum }_{i = 1 to k = K}^{K} {\sum }_{x ϵ k}^{N} dist ( {c}_{i} , x ) \qquad ( Eq . 13 )$$

where x(i)=Image intensity at point i∈lx(i)∈R³, cᵢ—cluster centre value ∈R³ The final clustering map is given by X_{pred} where each point in l is allocated either of cluster-foreground or background.

### Online Object of Interest Detection

FIG. 7 is a Harrflowchart of an illustrative process 700 for online detection of objects in images using a set of trained machine learning (ML) models, in accordance with some embodiments of the technology described herein. Process 700 may be executed by any suitable computing device(s) and/or system. For example, process 700 may be executed by image segmentation system 300 described herein with reference to FIG. 3.

Process 702 begins at act 702, during which one or multiple images are received. The image(s) may be image(s) of objects of a particular type. For example, the image(s) may be image(s) of power electronics equipment (e.g., equipment hanging on transmission types). The image(s) may be captured by any suitable device or devices. For example, the image(s) may be captured by an aerial platform (e.g., one or more cameras or other sensors on an unmanned aerial vehicle (UAV) or a manned aerial vehicle). As another example, the image(s) may be captured using one or more sensors configured to monitor an area (e.g., an area containing power electronics equipment or any other suitable types of objects).

It should be noted that each image received may be of any suitable type of object and that there may be multiple objects of that type in the image. For example, the image may be of power electronics equipment and there may be multiple instances of the power electronics equipment in the image. Each of the image(s) may be in any suitable image format and may be of any suitable size and/or resolution. In some embodiments, an image received at act 702 may have at least 10K, at least 50K, at least 100K, at least 500K, at least 1M pixel values. The image may be a single-channel image (e.g., a grayscale image) or a multi-channel image (e.g., a color image).

In some embodiments, the images may be received as a stream of images during operation of the sensor(s) capturing the images. Any suitable number of images may be received in a short amount of time, for example, hundreds or thousands of images within minutes or seconds. In some embodiments, the process 700 may be used to process the received images in real time upon receiving them. For example, in some embodiments, the process 700 may be used to process each received image (e.g., by segmenting object(s) in the image from their background) within a threshold amount of time of receiving each image (e.g. within 50 ms, 100 ms, 500 ms, 1 second, 10 seconds, 30 seconds, 1 minute, 5 minute). In some embodiments, the process 700 may receive multiple images, at act 702, and may buffer these images prior to processing them in one batch or multiple batches.

Next, to process the image(s) received at act 702, a particular ML segmentation model is accessed at act 704 such that it may be applied to the image(s) at act 706. Accessing the particular ML segmentation model at act 704 may involve loading at least some of the parameter values defining the particular ML segmentation model (e.g., neural network weights, cluster definitions, etc.), for example, from ML models data store 322 part of data persistence layer 308 in image segmentation system 300. Accessing the particular segmentation model may further involve loading and configuring to run the software that will applying the ML segmentation model to the image(s). This may involve, for example, loading a segmentation module, from among segmentation modules 310, that implements the particular ML segmentation model.

The particular ML segmentation model accessed at act 704 may be one of multiple possible ML segmentation models that could be utilized at act 706. The specific ML segmentation model to be accessed at 704 may have been determined in advance, for example, as a model initially selected to be used as part of process 700 before process 700 is initiated or as a model selected during execution of process 700 (e.g., during acts 712, 714, and 716). In some embodiments, the model to be accessed may be identified by checking a configuration parameter or parameters of the system executing process 700. As described herein, process 700 involves repeatedly evaluating performance of one or more ML models and selecting a particular one of the evaluated ML models to be used for processing images. That selection may be reflected in one or more configuration parameters, which may be consulted at act 704 to determine which particular ML segmentation model is to be loaded and used at act 706 for segmenting the image(s) received at act 702.

Regardless of which ML segmentation model is accessed at act 704, that ML segmentation model is applied to one or more images at act 706. At act 706, each particular image to be processed is processed, using the ML segmentation model selected at act 704, such that the object(s) in the particular image are segmented from their background in the particular image to obtain a respective segmentation mask. The segmentation mask may identify pixels associated with the object(s) in the image and pixels associated with the background of the object(s) in the image. Examples of images and corresponding segmentation masks are shown in FIGS. 2C and 5A.

Any of the ML segmentation models described herein may be used at act 706 including, for example, a multi-encoder ML segmentation model, a CNN U-Net model, a CNN fully convolutional neural network model, a k-means clustering model, and/or any other ML model trained to perform segmentation on images.

At 708, a determination is made as to whether a model evaluation step is to be performed. In particular, at 708, a determination may be made to evaluate performance of one or more ML segmentation models that could be used at act 706. For example, in some embodiments, the evaluation may involve an evaluation of the performance of the ML segmentation model that has been used at act 706 as well as an evaluation of one or more other ML segmentation models that could be used instead of the ML segmentation model that has been used at 706. For instance, while processing a stream of images using a CNN U-Net model, a determination may be made at act 708, to evaluate the performance of the CNN U-Net model (which has been in use), a multi-encoder ML segmentation model, and a clustering model.

As another example, in some embodiments, the evaluation may involve an evaluation of the performance of ML segmentation models that have not been used at act 706. For instance, while processing a stream of images using a CNN U-Net model, a determination may be made at act 708, to evaluate the performance of a multi-encoder ML segmentation model and a clustering model (but not the CNN U-Net model).

The determination to evaluate performance of one or more models may be made in any suitable way. For example, in some embodiments, the evaluation may be performed according to a pre-specified schedule and evaluation of the models may be triggered according to this schedule. For example, the schedule may indicate periodic evaluation of ML segmentation model performance (e.g., hourly, daily, weekly, bi-weekly, monthly, etc.). As another example, the evaluation may be performed after a threshold number of images has been processed and evaluation of the models may be triggered when the number of images received at act 702 exceeds the threshold number.

As yet another example, the evaluation may be performed in response to a triggering event. For example, process 700 may involve monitoring performance of the selected trained ML segmentation model (i.e., the model accessed at act 704) and determining to trigger evaluation (at 708) based on one or more performance measures. For example, process 700 may involve monitoring performance of the selected trained ML segmentation model based on its segmentation performance (e.g., as evaluated by one or more human experts or other algorithms on images also processed by the selected ML segmentation model, or by periodically feeding the selected ML segmentation model an image or multiple images for which ground truth data is available and determining how well the selected ML segmentation model performs on such image(s)). Evaluation, at 708, may be triggered when the segmentation performance falls below a target threshold or outside of a target range. The segmentation performance may be determined using an intersection-over-union (IoU) metric or in any other suitable way.

As another example, process 700 may involve monitoring performance of the selected trained ML segmentation model based on its computational performance (e.g., amount of processing power utilized). Evaluation, at 708, may be triggered when the computational burden of employing the selected trained ML segmentation model exceeds a threshold or falls outside of a target range (implying that the technique is too computationally demanding). As yet another example, process 700 may involve monitoring performance of the selected trained ML model using multiple types of performance measures (e.g., both segmentation and computational performance measures) and determining whether to evaluate performance of multiple models using results of multiple performance measures (e.g., when segmentation performance is not below but is close to the target performance threshold and when computational performance is not above but is close to the computational complexity threshold, triggering evaluation, even if any individual performance measure would not be a sufficient trigger on its own).

When it is determined, at act 708, that evaluation is to not be triggered, process 700 returns to act 702. On the other hand, when it is determined at act 708 that evaluation is to be triggered (irrespective of how that determination is made), process 700 proceeds to act 710 where the performance of the selected segmentation ML model and one or more other ML models is evaluated. (Though, as noted above, in other embodiments, performance of only one or more other ML models may be evaluated).

At act 710, the performance of the selected ML segmentation model and one or more other models may be evaluated using any suitable performance metric(s). Examples include one or more computational performance metrics (e.g., measuring an amount of time, processing power, memory, bandwidth, and/or other computational resources used to segment one or more images) and/or one or more segmentation performance metrics (e.g., an intersection over union IOU metric or its, e.g., natural, logarithm).

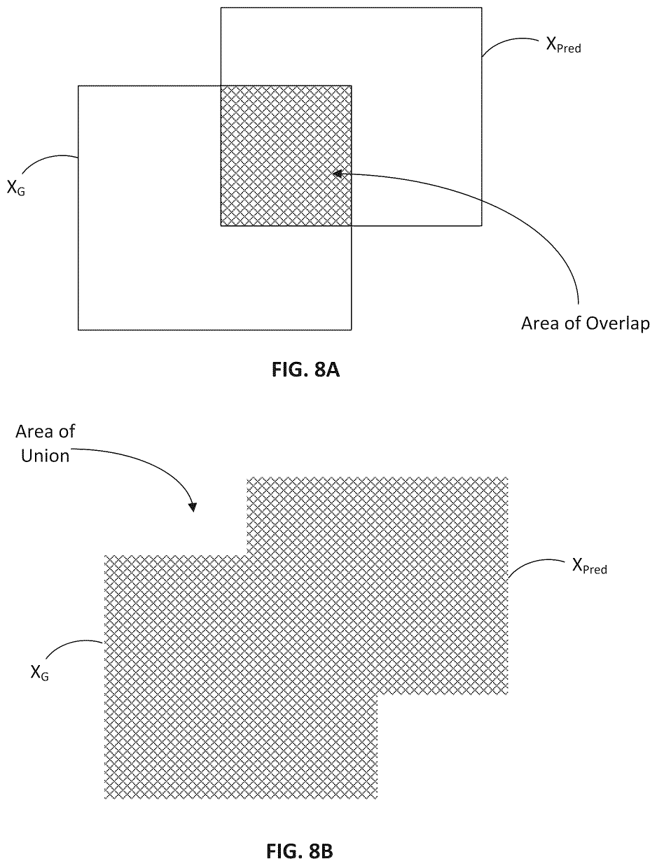

FIGS. 8A and 8B illustrate aspects of determining an intersection over union (IOU) metric for segmentation performance, in accordance with some embodiments of the technology described herein. The intersection over union metric measures segmentation performance of an algorithm by comparing the predicted segmentation “Xpred” against the ground truth segmentation. As shown in FIGS. 8A and 8B, the quality of the segmentation is a function of the intersection between the ground truth and predicted segmentations (shown in 8A) relative to the area of the union of the two segmentations (shown in FIG. 8B). The intersection over union metric determines a ratio of these quantities, and may do so on a logarithmic or any other suitable scale. For example, IoU may be determined according to:

$$IOU = - ln ( \frac{{X}_{G} ⋂ {X}_{pred}}{{X}_{G} ⋃ {X}_{pred}} ) \qquad ( Eq . 16 )$$

When evaluating the performance of the various ML models and segmentation techniques, that evaluation is to be performed on images and corresponding labeled segmentations. For example, such an evaluation dataset may be obtained in a number of ways. For example, one or more images received at 702 may be segmented by one or more human experts (e.g., assisted by software), or automatically by another segmentation method, and these images and their segmentations may form an evaluation dataset. As another example, some labeled data may be set aside for periodic evaluations of models (and these data may not be used for training, validating, or testing the ML segmentation models during their creation, tuning and initial testing).

After the various ML models are evaluated, the evaluation results may be used identify a particular ML segmentation model to use going forward. This may be done in accordance with one or more ML model selection rules, which may encode model selection logic based on evaluation results. For example, the ML model selection rule(s) may include a rule indicating that a model having the best segmentation performance should be selected, from among those models evaluated. As another example, the ML model selection rule(s) may include a rule indicating that an ML model having the best computational performance should be selected, so long it has at least a threshold segmentation performance.

As yet another example, the ML model selection rule(s) may include a selection rule encoding a relative performance criterion. For example, the rule may indicate that a new ML segmentation model should be selected only when the new ML segmentation model outperforms the currently selected ML model at least by a threshold amount for a particular performance measure (e.g., segmentation performance, computational performance). As another example, the rule may indicate that the new ML segmentation model should be selected even if its segmentation performance is worse than that of the currently selected ML (e.g., within reason, for example, 4% worse) so long as the computational performance of the new ML segmentation model is better than that of the currently selected ML model. In this way, gains in computational complexity may be achieved with negligible or at least tolerable losses in segmentation performance. The opposite can also be true and a rule may encode the selection logic such that gains in segmentation performance may be achieved with negligible or at least tolerable losses in computation performance.

After a particular ML model is identified, at act 712, via the selection logic, process 700 proceeds to act 714, where it is determined whether the model identified at 712 is the same as the currently selected ML model (i.e., the model selected at act 704 and used at 706). If so, the process simply returns to act 702 and acts 704 and onward are repeated. On the other hand, if a new model has been identified at 712, that new model is set as the “currently selected model” (e.g., by setting appropriate configuration parameter(s)) at act 716, and the process returns to act 702, whereby subsequent acts are performed with the newly selected ML model.

It should be appreciated that process 700 is illustrative and that there are variations. First, process 700 was described as providing the ability to evaluate-periodically or in response to triggering events-performance of multiple ML segmentation models and selecting one of these models for subsequent processing based on the results of the evaluation. However, the technique is not limited to using only machine learning based methods for segmentation and, in other embodiments, one or more other types of segmentation techniques may be considered as potential methods to adopt as the “current segmentation method”, as aspects of the online evaluation loop are not limited to evaluating performance only of ML-based segmentation methods.

Another variation of the process 700 is that the online evaluation loop may involve processing techniques to perform tasks beyond segmentation. For example, act 706 may involve classifying an object in a received image (e.g., as having an anomaly, as being of a particular type, etc.) and the online evaluation loop may be configured to evaluate performance of one or more classification algorithms in addition to or (indeed) instead of segmentation methods. The classification techniques may be ML based, in some embodiments.

Various aspects are described in this disclosure, which include, but are not limited to, the following aspects:

1. A method for detecting objects in images using machine learning (ML), the method comprising: using at least one computer hardware processor to perform: obtaining an image of an object; and segmenting the object in the image from background of the object in the image using to obtain a segmentation mask for the image, the segmenting comprising: processing the image with a first trained ML model to obtain first image features; transforming the first image features to second image features for processing by a second trained ML model; and processing the second image features using the second trained ML model to obtain the segmentation mask for the image, wherein the segmentation mask identifies pixels associated with the object in the image and pixels associated with background of the object in the image.

2. The method of aspect 1, wherein obtaining the image of the object comprises capturing the image of the object using an unmanned aerial vehicle.

3. The method of aspect 1, wherein the image of the object is an image of power electronics equipment.

4. The method of aspect 1, wherein processing the image with the first trained ML model to obtain first image features comprises encoding the image using the first trained ML model to obtain the first image features.

5. The method of aspect 4, wherein the first image features comprise feature maps determined by processing the image using the first trained ML model.

6. The method of aspect 5, wherein the first trained ML model is a neural network model.

7. The method of aspect 5, wherein the first trained ML model comprises a convolutional neural network model having a series of convolutional layers.

8. The method of aspect 5, wherein the first trained ML model is a portion of a trained neural network model having a ResNet architecture, a visual geometry group (VGG) architecture, or an Inception architecture.

9. The method of aspect 4, wherein the first trained ML model has at least 250,000 parameter values.

10. The method of aspect 1, wherein at least some of parameter values of the first trained ML model are obtained by transfer learning.

11. The method of aspect 10, wherein the at least some of the parameter values of the first trained ML model were estimated by training on image data including multiple types of objects of a different type than the object's type.

12. The method of aspect 1, wherein transforming the first image features to second image features for processing by the second trained ML model is performed by a using a trained ML transformation model.

13. The method of aspect 12, wherein the trained ML transformation model comprises an encoder of a trained autoencoder (AE) model or a trained variational autoencoder (VAE) model.

14. The method of aspect 12, wherein dimensionality and/or shape of the transform space of the trained AE model or the trained VAE model matches dimensionality and/or shape of input to second trained ML model.

15. The method of aspect 12, wherein the trained ML transformation model comprises at least 10,000 parameter values.

16. The method of aspect 1, wherein the second trained ML model is trained to segment, from background, objects of a same type as the type of the object.

17. The method of aspect 1, wherein the second trained ML model is a neural network model.

18. The method of aspect 17, wherein the second trained ML model comprises a convolutional neural network model comprising a series of convolutional layers.

19. The method of aspect 17, wherein the second trained ML model has a U-Net architecture.

20. The method of aspect 19, wherein the second trained ML model has at least 1 million (1M) parameter values.

21. The method of aspect 1, wherein the first trained ML model was trained on image data including images of numerous types of objects each of a different type than the object's type; and wherein the second trained ML was trained on image data including images of objects of a same type as the object's type.

22. A system, comprising: at least one computer hardware processor; and at least one non-transitory computer-readable storage medium storing processor-executable instructions that, when executed by the at least one computer hardware processor, cause the at least one computer hardware processor to perform the method of any one of aspects 1-21.

23. At least one non-transitory computer-readable storage medium storing processor-executable instructions that, when executed by at least one computer hardware processor, cause the at least one computer hardware processor to perform the method of any one of aspects 1-21.

24. A method for detecting objects in images using machine learning (ML), the method comprising: using at least one computer hardware processor to perform: obtaining an image of an object; and segmenting the object in the image from background of the object in the image to obtain a segmentation mask for the image by using multiple trained encoders including: a first encoder whose weights are obtained by transfer learning; and a second encoder whose weights are trained using images of objects of a same type as the object, wherein the segmentation mask identifies pixels associated with the object in the image and pixels associated with background of the object in the image.

25. The method of aspect 24, wherein obtaining the image of the object comprises capturing the image of the object using an unmanned aerial vehicle.

26. The method of aspect 24, wherein the image of the object is an image of power electronics equipment.

27. The method of aspect 24, wherein segmenting the objects comprises: encoding the image using the first encoder to obtain first image features, wherein parameter values of the first encoder are obtained from a portion of another trained neural network model.

28. The method of aspect 27, wherein the first image features comprise feature maps determined by processing the image using the first encoder.

29. The method of aspect 28, wherein the other trained neural network model comprises a series of convolutional layers.

30. The method of aspect 29, wherein the other trained neural network model has a ResNet architecture, a visual geometry group (VGG) architecture, or an Inception architecture.

31. The method of aspect 27, wherein the first encoder has at least 250,000 parameter values.

32. The method of aspect 24, wherein the at least some of the parameter values of the first encoder were estimated by training on image data including multiple types of objects of a different type than the object's type.

33. The method of aspect 27, wherein segmenting the object further comprises: transforming, using the second encoder, the first image features to second image features for processing by a second trained ML model.

34. The method of aspect 33, wherein the second encoder is an encoder of a trained autoencoder (AE) model or a trained variational autoencoder (VAE) model.

35. The method of aspect 34, wherein dimensionality and/or shape of the transform space of the trained AE model or the trained VAE model matches dimensionality and/or shape of the second trained ML model.

36. The method of aspect 33, wherein the second encoder comprises at least 10,000 parameter values.

37. The method of aspect 33, wherein the second trained ML model is trained to segment, from background, objects of a same type as the type of the object, wherein segmenting the object further comprises processing the second image features using the second trained ML model to obtain the segmentation mask for the image.

38. The method of aspect 37, wherein the second trained ML model is neural network model.

39. The method of aspect 38, wherein the neural network model comprises a series of convolutional layers.

40. The method of aspect 38, wherein the second trained ML model has a U-Net architecture.

41. The method of aspect 37, wherein the second trained ML model has at least 1 million (1M) parameter values.

42. A system, comprising: at least one computer hardware processor; and at least one non-transitory computer-readable storage medium storing processor-executable instructions that, when executed by the at least one computer hardware processor, cause the at least one computer hardware processor to perform a method of any one of aspects 24-41.

43. At least one non-transitory computer-readable storage medium storing processor-executable instructions that, when executed by at least one computer hardware processor, cause the at least one computer hardware processor to perform any one of aspects 24-41.

44. A method for online detection of objects in images using a set of trained machine learning (ML) models, the method comprising: using at least one computer hardware processor to perform: (a) responsive to receiving images of objects of a first type, processing the received images, using a selected trained ML model from among the set of trained ML models, to segment objects of the first type in the images to obtain respective segmentation masks; (b) during performance of (a) and either in accordance with a prespecified schedule and/or responsive to one or more triggering events, evaluating performance of the selected trained ML model and one or more other trained ML models in the set of trained ML models using one or more measures of performance; identifying, from among the selected trained ML model and the one or more other trained ML models, a particular trained ML based on its performance on the one or more measures of performance and in accordance with one or more ML model selection rules; when the selected trained model is identified as the particular trained ML model, continuing performance of (a) using the selected trained ML model; and when the selected trained ML model is not identified as the particular trained ML model, continuing performance of (a) using the particular trained ML model instead of the selected trained ML model and treating the particular trained ML model as the selected trained ML model next time (b) is performed.

45. The method of aspect 44, wherein the one or more measures of performance comprises a segmentation performance metric.

46. The method of claim 45, wherein the segmentation performance metric is an intersection of over union (IOU) metric for measuring accuracy of segmenting objects of the first type in a set of one or more images.

47. The method of claim 44, wherein the one or more measures of performance comprises a computational performance metric providing a measure of an amount of time used by an ML model to segment objects of the first type in a set of one or more images.

48. The method of claim 44, wherein the one or more ML model selection rules comprises a rule for selecting an ML model, from among a set of ML models, based on values of a computational performance metric and/or a segmentation performance metric for ML models in the set of ML models.

49. The method of claim 48, wherein the one or more ML model selection rules comprises a rule for selecting an ML model, from among a set of ML models, based on values of a computational performance metric and a segmentation performance metric for ML models in the set of ML models.

50. The method of claim 44, wherein the particular trained ML model is one of a U-Net neural network model, a multi-encoder neural network segmentation model, and a K-means clustering algorithm.

51. The method of claim 50, wherein the multi-encoder neural network model comprises: a first encoder whose weights are obtained by transfer learning; a second encoder whose weights are trained using images of objects of a same type as the object; and a neural network model, wherein the first encoder is trained to process an image to obtain first image features, the second encoder is trained to transform first image features to second image features for subsequent processing by the neural network model, and the neural network model is trained to process the second image features to obtain a segmentation mask for the image, wherein the segmentation mask identifies pixels associated with the object in the image and pixels associated with background of the object in the image.

52. A system, comprising: at least one computer hardware processor; and at least one non-transitory computer-readable storage medium storing processor-executable instructions that, when executed by the at least one computer hardware processor, cause the at least one computer hardware processor to perform a method of any one of aspects 44-51.

53. At least one non-transitory computer-readable storage medium storing processor-executable instructions that, when executed by at least one computer hardware processor, cause the at least one computer hardware processor to perform a method of any one of aspects 44-51.

### Example Computer System

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, cloud-based computing environments, distributed computing environments that include any of the above systems or devices, and the like.

FIG. 9 illustrates an example of a suitable computing system environment 900 on which aspects of the technology described herein may be implemented. The computing system environment 900 is only one example of a suitable computing environment and is not intended to suggest any limitation as to the scope of use or functionality of the technology described herein. Neither should the computing environment 900 be interpreted as having any dependency or requirement relating to any one or combination of components illustrated in the exemplary operating environment 900.

With reference to FIG. 9, an exemplary system for implementing the technology described herein includes a general purpose computing device in the form of a computer 900. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (ELISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a flash drive 951 that reads from or writes to a removable, nonvolatile memory 952 such as flash memory, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media described above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. An actor may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 981 and a wide area network (WAN) 983, but may also include other networks. Such networking environments are commonplace in offices, enterprise-wide computer networks, intranets and the Internet.

When used in a LAN networking environment, the computer 910 is connected to the LAN 981 through a network interface or adapter 980. When used in a WAN networking environment, the computer 910 typically includes a modem 982 or other means for establishing communications over the WAN 983, such as the Internet. The modem 982, which may be internal or external, may be connected to the system bus 921 via the actor input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the dataset fields with locations in a computer-readable medium that conveys relationship between the dataset fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 4A, 4B, and 7. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for online detection of objects in images using a set of trained machine learning (ML) models, the method comprising:
using at least one computer hardware processor to perform:
(a) responsive to receiving images of objects of a first type, processing the received images, using a selected trained ML model from among the set of trained ML models, to segment objects of the first type in the images to obtain respective segmentation masks;
(b) during performance of (a) and either in accordance with a prespecified schedule and/or responsive to one or more triggering events,
evaluating performance of the selected trained ML model and one or more other trained ML models in the set of trained ML models using one or more measures of performance;
identifying, from among the selected trained ML model and the one or more other trained ML models, a particular trained ML based on its performance on the one or more measures of performance and in accordance with one or more ML model selection rules;
when the selected trained model is identified as the particular trained ML model, continuing performance of (a) using the selected trained ML model; and
when the selected trained ML model is not identified as the particular trained ML model, continuing performance of (a) using the particular trained ML model instead of the selected trained ML model and treating the particular trained ML model as the selected trained ML model next time (b) is performed.

2. The method of claim 1, wherein the one or more measures of performance comprises a segmentation performance metric.

3. The method of claim 2, wherein the segmentation performance metric is an intersection of over union (IOU) metric for measuring accuracy of segmenting objects of the first type in a set of one or more images.

4. The method of claim 1, wherein the one or more measures of performance comprises a computational performance metric providing a measure of an amount of time used by an ML model to segment objects of the first type in a set of one or more images.

5. The method of claim 1, wherein the one or more ML model selection rules comprises a rule for selecting an ML model, from among a set of ML models, based on values of a computational performance metric and/or a segmentation performance metric for ML models in the set of ML models.

6. The method of claim 5, wherein the one or more ML model selection rules comprises a rule for selecting an ML model, from among a set of ML models, based on values of a computational performance metric and a segmentation performance metric for ML models in the set of ML models.

7. The method of claim 1, wherein the particular trained ML model is one of a U-Net neural network model, a multi-encoder neural network segmentation model, and a K-means clustering algorithm.

8. The method of claim 7, wherein the multi-encoder neural network model comprises:
a first encoder whose weights are obtained by transfer learning;
a second encoder whose weights are trained using images of objects of a same type as the object; and
a neural network model,
wherein the first encoder is trained to process an image to obtain first image features, the second encoder is trained to transform first image features to second image features for subsequent processing by the neural network model, and the neural network model is trained to process the second image features to obtain a segmentation mask for the image,
wherein the segmentation mask identifies pixels associated with the object in the image and pixels associated with background of the object in the image.

9. A system, comprising:
at least one computer hardware processor; and
at least one non-transitory computer-readable storage medium storing processor-executable instructions that, when executed by the at least one computer hardware processor, cause the at least one computer hardware processor to perform a method for online detection of objects in images using a set of trained machine learning (ML) models, the method comprising:
(a) responsive to receiving images of objects of a first type, processing the received images, using a selected trained ML model from among the set of trained ML models, to segment objects of the first type in the images to obtain respective segmentation masks;
(b) during performance of (a) and either in accordance with a prespecified schedule and/or responsive to one or more triggering events,
evaluating performance of the selected trained ML model and one or more other trained ML models in the set of trained ML models using one or more measures of performance;
identifying, from among the selected trained ML model and the one or more other trained ML models, a particular trained ML based on its performance on the one or more measures of performance and in accordance with one or more ML model selection rules;
when the selected trained model is identified as the particular trained ML model, continuing performance of (a) using the selected trained ML model; and
when the selected trained ML model is not identified as the particular trained ML model, continuing performance of (a) using the particular trained ML model instead of the selected trained ML model and treating the particular trained ML model as the selected trained ML model next time (b) is performed.

10. The system of claim 9, wherein the one or more measures of performance comprises a segmentation performance metric.

11. The system of claim 10, wherein the segmentation performance metric is an intersection of over union (IOU) metric for measuring accuracy of segmenting objects of the first type in a set of one or more images.

12. The system of claim 9, wherein the one or more measures of performance comprises a computational performance metric providing a measure of an amount of time used by an ML model to segment objects of the first type in a set of one or more images.

13. The system of claim 9, wherein the one or more ML model selection rules comprises a rule for selecting an ML model, from among a set of ML models, based on values of a computational performance metric and a segmentation performance metric for ML models in the set of ML models.

14. The system of claim 9, wherein the particular trained ML model is one of a U-Net neural network model, a multi-encoder neural network segmentation model, and a K-means clustering algorithm.

15. The system of claim 14, wherein the multi-encoder neural network segmentation model comprises:
a first encoder whose weights are obtained by transfer learning;
a second encoder whose weights are trained using images of objects of a same type as the object; and
a neural network model,
wherein the first encoder is trained to process an image to obtain first image features, the second encoder is trained to transform first image features to second image features for subsequent processing by the neural network model, and the neural network model is trained to process the second image features to obtain a segmentation mask for the image,
wherein the segmentation mask identifies pixels associated with the object in the image and pixels associated with background of the object in the image.

16. At least one non-transitory computer-readable storage medium storing processor-executable instructions that, when executed by at least one computer hardware processor, cause the at least one computer hardware processor to perform a method for online detection of objects in images using a set of trained machine learning (ML) models, the method comprising:
(a) responsive to receiving images of objects of a first type, processing the received images, using a selected trained ML model from among the set of trained ML models, to segment objects of the first type in the images to obtain respective segmentation masks;
(b) during performance of (a) and either in accordance with a prespecified schedule and/or responsive to one or more triggering events,
evaluating performance of the selected trained ML model and one or more other trained ML models in the set of trained ML models using one or more measures of performance;
identifying, from among the selected trained ML model and the one or more other trained ML models, a particular trained ML based on its performance on the one or more measures of performance and in accordance with one or more ML model selection rules;
when the selected trained model is identified as the particular trained ML model, continuing performance of (a) using the selected trained ML model; and
when the selected trained ML model is not identified as the particular trained ML model, continuing performance of (a) using the particular trained ML model instead of the selected trained ML model and treating the particular trained ML model as the selected trained ML model next time (b) is performed.

17. The at least one non-transitory storage medium of claim 16, wherein the one or more measures of performance comprises a segmentation performance metric, wherein the segmentation performance metric is an intersection of over union (IOU) metric for measuring accuracy of segmenting objects of the first type in a set of one or more images.

18. The at least one non-transitory storage medium of claim 16, wherein the one or more measures of performance comprises a computational performance metric providing a measure of an amount of time used by an ML model to segment objects of the first type in a set of one or more images.

19. The at least one non-transitory storage medium of claim 16, wherein the one or more ML model selection rules comprises a rule for selecting an ML model, from among a set of ML models, based on values of a computational performance metric and a segmentation performance metric for ML models in the set of ML models.

20. The at least one non-transitory storage medium of claim 16, wherein the particular trained ML model is one of a U-Net neural network model, a multi-encoder neural network segmentation model, and a K-means clustering algorithm.
